(19) United States
(12) Patent Application Publication
(10) Pub. No.: US 2025/0363289 A1
(43) Pub. Date: Nov. 27, 2025

(54) ARTIFICIAL INTELLIGENCE (AI)-ASSISTED POST EDITING

(71) Applicant: Lemon Inc., Grand Caymon (KY)

(72) Inventors: Linlin Chen, Culver City, CA (US); Tianhao He, Culver City, CA (US); Angel Jin, Los Angeles, CA (US); Mengyin Lu, Culver City, CA (US)

(21) Appl. No.: 18/672,420

(22) Filed: May 23, 2024

(51) Int. Cl. G06F 40/166; G06F 3/04842

(52) U.S. Cl. CPC G06F 40/166; G06F 3/04842

(57) ABSTRACT

Method, apparatus, and user interfaces for editing posts are described. In one example, an electronic device receives user input of at least a part of content of a post on a post editing page of an application on the electronic device. A suggested title of the post is generated based on the at least a part of content of the post. The suggested title of the post is provided on the post editing page. In response to receiving a user confirmation of the suggested title, the suggested title of the post is displayed on the post editing page.

### TECHNICAL FIELD

The present disclosure generally relates to post editing, and more specifically, to artificial intelligence (AI)-assisted post editing.

### BACKGROUND

AI-assisted editing refers to the use of artificial intelligence technology to help with editing text, images, video, or audio. This can include, for example, correcting grammar and spelling in text, enhancing images or improving the clarity and quality of audio recordings.

### SUMMARY

The present disclosure describes methods, apparatus, and user interfaces for editing a post.

In one aspect, the present disclosure describes a method. The method includes the following operations: receiving, by an electronic device, user input of at least a part of content of a post on a post editing page of an application on the electronic device; generating, based on the at least a part of content of the post, a suggested title of the post; providing, on the post editing page, the suggested title of the post; receiving a user confirmation of the suggested title of the post; and in response to receiving the user confirmation, displaying the suggested title of the post on the post editing page.

In another aspect, the present disclosure describes an apparatus including one or more processors and one or more computer-readable memories coupled to the one or more processors. The one or more computer-readable memories store instructions that are executable by the one or more processors to perform the above-described operations.

In still another aspect, the present disclosure describes a non-transitory computer-readable storage medium. The non-transitory computer-readable storage medium stores programing instructions executable by one or more processors to perform the above-described operations.

In some implementations, these general and specific aspects may be implemented using a system, a method, or a computer program, or any combination of systems, methods, and computer programs. The foregoing and other described aspects can each, optionally, include one or more of the following aspects.

In some implementations, generating, based on the at least a part of content of the post, the suggested title of the post includes: sending the at least the part of content of the post to one or more pre-trained generative artificial intelligence (GenAI) models; and receiving the suggested title of the post outputted by the one or more pre-trained GenAI models.

In some implementations, the one or more pre-trained GenAI models are executed in a remote server.

In some implementations, the one or more pre-trained GenAI models are executed in the electronic device.

In some implementations, the at least a part of content of the post comprises at least one of graphical content items or textual content items.

In some implementations, the at least a part of content of the post comprises one or more graphical content items. In such implementations, the method includes: receiving, by the electronic device, the one or more graphical content items at the post editing page of the application on the electronic device; generating, based on the one or more graphical content items, a textual description of the one or more graphical content items using a first model; and generating, based on the textual description of the graphical content items, the suggested title of the post using a second model.

In some implementations, the at least a part of content of the post comprises one or more graphical content items and one or more textual content items. In such implementations, the method includes: receiving, by the electronic device, the one or more graphical content items and the one or more textual content items at the post editing page of the application on the electronic device; generating, based on the one or more graphical content items, a textual description of the one or more graphical content items using a third model; and generating, based on the one or more textual content items and the textual description of the one or more graphical content items, the suggested title of the post using a fourth model.

In some implementations, the method includes: generating, based on the at least a part of content of the post, a plurality of titles of the post; and providing, on the post editing page, a suggestion of the plurality of titles of the post.

In some implementations, the method includes: receiving a user instruction to continue drafting the post; in response to receiving the user instruction, generating, based on existing content of the post, additional textual content; and inserting the additional textual content in the post.

In some implementations, the method includes: receiving, as a selected portion of textual content, a first user selection of a portion of textual content of the post; in response to receiving the first user selection, displaying, on the post editing page, one or more editing options; receiving, as a selected editing option, a second user selection of one of the one or more editing options; and in response to the second user selection, performing an editing operation corresponding to the selected editing option on the selection portion of textual content.

In some implementations, the method includes: providing, on the post editing page, one or more interactive elements for switching between multiple versions of user-confirmed post content; and in response to a user interaction with one of the one or more interactive elements, replacing current content of the post with one of the multiple versions of user-confirmed post content.

In some implementations, the method includes: receiving a user instruction to change a tone of textual content of the post; in response to receiving the user instruction, providing one or more tone options on the post editing page; receiving, as a selected tone option, a user selection of one of the one or more tone options; and generating new textual content of the post that corresponds to the selected tone option.

In some implementations, the method includes: providing, on the post editing page, a first interactive element to exit an AI-assisted editing mode; receiving a first user interaction with the first interactive element; in response to receiving the first user interaction with the first interactive element, providing, on the post editing page, a second interactive element for prompting user feedback in a nondisruptive manner.

In some implementations, the method include: receiving a second user interaction with the second interactive element; and in response to receiving the second user interaction, providing a feedback page.

In some implementations, the method includes: in response to determining that no user interaction with the second interactive element is received within a threshold duration, dismissing the second user interaction, from displaying on the post editing page.

The details of one or more implementations of the subject matter of this disclosure are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-1K illustrate an example user interface (UI) for editing a post, according to one or more implementations of the disclosure.

FIGS. 2A-2F illustrate an example UI for editing a post, according to one or more implementations of the disclosure.

FIGS. 3A-3E illustrate an example UI for editing a post, according to one or more implementations of the disclosure.

FIGS. 4A-4H illustrate an example UI for editing a post, according to one or more implementations of the disclosure.

FIGS. 5A-5I illustrate an example UI for editing a post, according to one or more implementations of the disclosure.

FIGS. 6A-6G illustrate an example UI for editing a post, according to one or more implementations of the disclosure.

FIGS. 7A-7C illustrate an example UI for editing a post, according to one or more implementations of the disclosure.

FIGS. 8A-8D illustrate an example UI for editing a post, according to one or more implementations of the disclosure.

FIGS. 9A-9I illustrate an example UI for editing a post, according to one or more implementations of the disclosure.

FIGS. 10A-10H illustrate an example UI for editing a post, according to one or more implementations of the disclosure.

FIGS. 11A-11D illustrate an example UI for editing a post, according to one or more implementations of the disclosure.

FIGS. 12A-12E illustrate an example UI for editing a post, according to one or more implementations of the disclosure.

FIGS. 13A-13D illustrate an example UI for editing a post, according to one or more implementations of the disclosure.

FIGS. 14A-14D illustrate an example UI for editing a post, according to one or more implementations of the disclosure.

FIGS. 15A-15D illustrate an example UI for editing a post, according to one or more implementations of the disclosure.

FIGS. 16A-16D illustrate an example UI for editing a post, according to one or more implementations of the disclosure.

FIGS. 17A-17D illustrate an example UI for editing a post, according to one or more implementations of the disclosure.

FIGS. 18A-18B illustrate an example UI for editing a post, according to one or more implementations of the disclosure.

FIGS. 19A-19B illustrate an example UI for editing a post, according to one or more implementations of the disclosure.

FIGS. 20A-20B illustrate an example UI for editing a post, according to one or more implementations of the disclosure.

FIG. 21 illustrates a block diagram of an example process of editing a post, according to one or more implementations of the disclosure.

FIG. 22 illustrates a block diagram of an example computer system, according to one or more implementations of the disclosure.

Like reference numbers and designations in the various drawings indicate like elements.

### DETAILED DESCRIPTION

Example techniques are described for leveraging artificial intelligence (AI) for post editing in one or more applications/programs of an electronic device. For example, the applications/programs can include one or more of a social networking application, a photo/video posting/sharing application, a web-browsing application, or integrate functionalities of one or more of these and other applications/programs. An example application can be a video sharing application that allows a user to create content, for example, by uploading and editing media such as text, image, video, and/or audio, and sharing the created content publicly or within one or more groups, for example, in the form of a post. The application can also include social networking features or services that allow other users to interact, through the application, with the user who uploads or create the post.

A post can include graphics, e.g., image and/or video, text, and/or audio. A post can have different viewing permissions, such as viewing permissions based on the creator's approval, and/or viewing time limits from a creation time for the post. As an example, a post can include a temporary story that is available for viewing for a limited amount of time, a post that is available for viewing for a longer period of time, a sound, a product or promotion, or a livestream.

Users can view posts and interact with posts in different viewing modes. For example, the system can provide a feed mode that presents a stream of posts to the user. In some examples, the posts presented to the user are personalized, i.e., the posts are curated based on the user's interests, prior interactions, and viewing habits. The system can also provide a full post mode that presents each post in a larger portion of the screen and displays more information about the post such as comments, likes, and shares for the post. The full post mode can also support enhanced user interaction with the content, allowing for actions like liking, commenting, sharing, and exploring the content creator's profile. Additional interactive features in the full post mode may include the ability to create duets or stitches with the media, provided these functionalities are enabled by the content creator.

The described techniques provide example user interfaces that can provide media items, such as images or videos, for display and that can allow a user to create a new media item more easily, such as a title and/or textual description, related to the media items provided for display. In some implementations, a user interface can include everything from the layout of the screen, the design of the buttons and icons, to the responsiveness of the electronic device when a user interacts with it. For an electronic device that includes a display or screen such as a touchscreen, the user interface can include a graphical user interface (GUI). In some implementations, the user interacts with the GUI, for example, through finger contacts and/or gestures on or in front of the touchscreen.

The user interfaces can be provided for display by a system implemented as computer programs on one or more computers in one or more locations. The system can include an electronic device such as smart phones, pads, tablets, TVs, or other computer devices or terminals. In some implementations, the system can also include one or more servers that are remote from the electronic device.

Example techniques are described that provide solutions to integrate AI into post editing functionalities of the application, allowing editing across multiple mediums, and offering sophisticated tools with enhanced efficiency and quality. In text editing, AI provides advanced grammar correction, style optimization, and content personalization, improving readability and engagement. For image editing, AI capabilities include automatic photo enhancements, object removal, and complex manipulative tasks that traditionally require extensive manual effort. In video editing, AI facilitates automated clip selection, seamless transitions, and color correction, streamlining post-production workflows. Furthermore, AI can enhance audio editing by offering noise reduction, speech clarity enhancement, and even tone adjustment.

In some examples, the described techniques can leverage AI to automatically generate caption ideas from user-provided prompts and photos, continue adding to existing text input by a user, alter the tone of descriptions, summarize content, and suggest appropriate titles for a post. The title of a post can include, for example, a caption, a headline, a header, a summary, a synopsis, an abstract or another name that describes a content of the post. In some implementations, a title of a post can be used to attract views from other users, especially in a social networking application. In some implementations, titles can be used in content search and help users identify relevant contexts. For example, titles can improve the searchability and discoverability of media content through the strategic use of keywords, aiding in positioning content favorably in both platform-specific and external search engine results. Titles can also provide clarity and context, enhancing user engagement by drawing interest with compelling language. Additionally, titles can provide accessibility by offering a textual description of media content, helping viewers who prefer silent viewing.

The described techniques can also enable edits to selected text segments and manage version control to track different modifications resulting from AI-assisted edits. In some implementations, after users have finished using the AI assist features, the system can collect feedback seamlessly without disrupting the user's workflow through intrusive methods like pop-ups or redirecting to another page. These capabilities can collectively enhance the user experience by integrating AI-assisted editing functionalities within the mobile application environment effectively and efficiently.

The described techniques can help manage the process of transforming graphical content into textual content, sending requests to third-party AI model providers in a manner that ensures the output is consistent, inspirational, and compliant. In some implementations, the described techniques can effectively handle cases where users' inputs might be misinterpreted. In some implementations, the described techniques preserve the integrity of user inputs while minimizing latency and preventing significant data loss. In some implementations, the described techniques incorporate version control to manage diverse inputs affecting the display on mobile app screens, where user inputs and AI-generated outputs interact directly. In some implementations, the described techniques allow for selective modifications of text via a side menu on the same mobile app screen, enhancing usability.

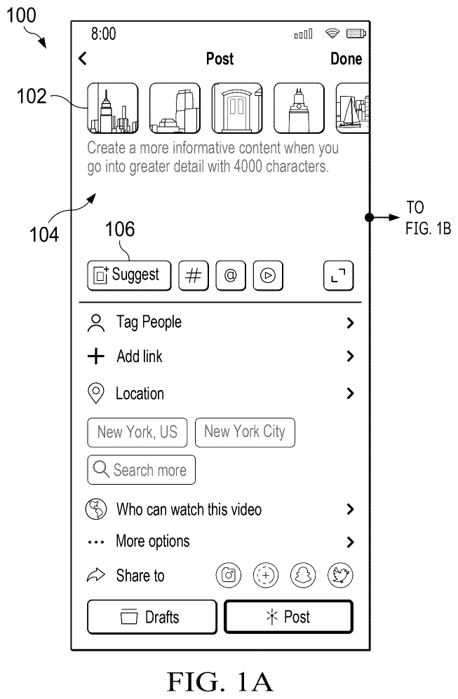

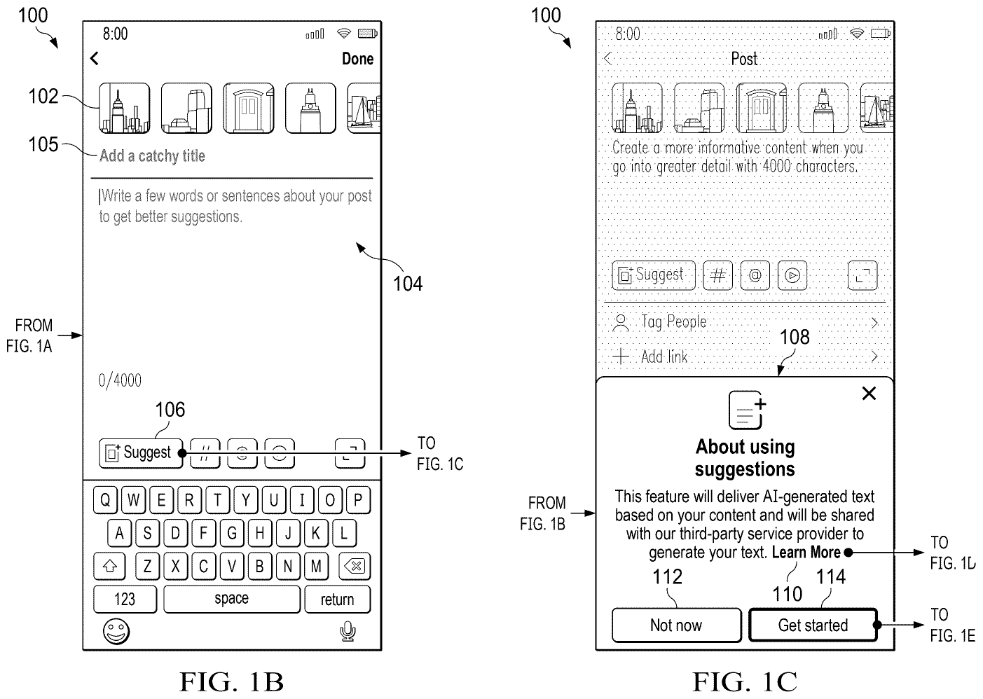

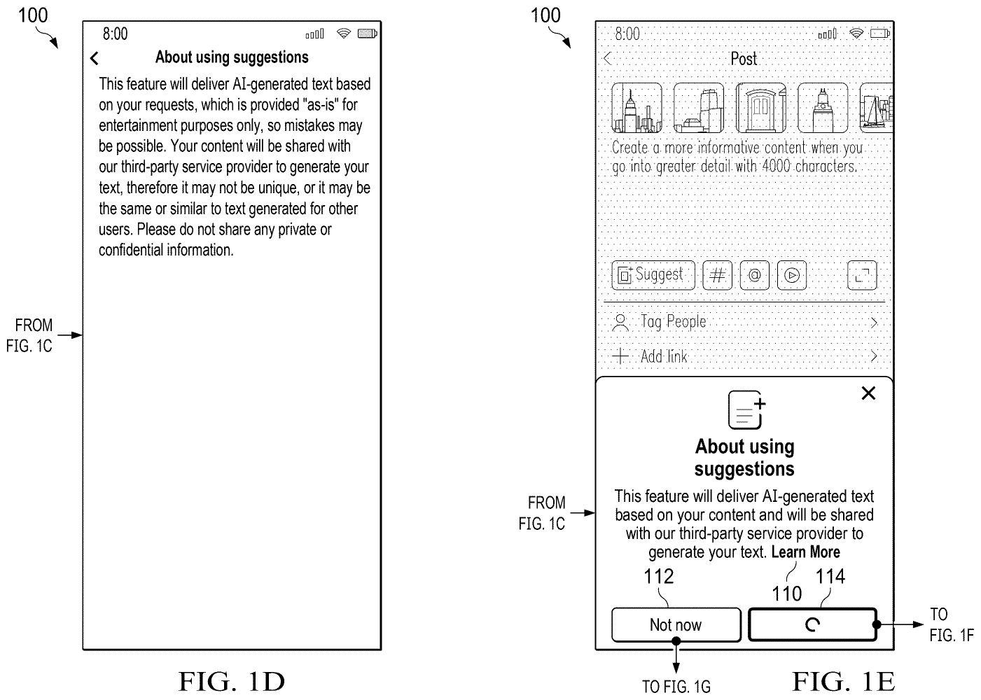

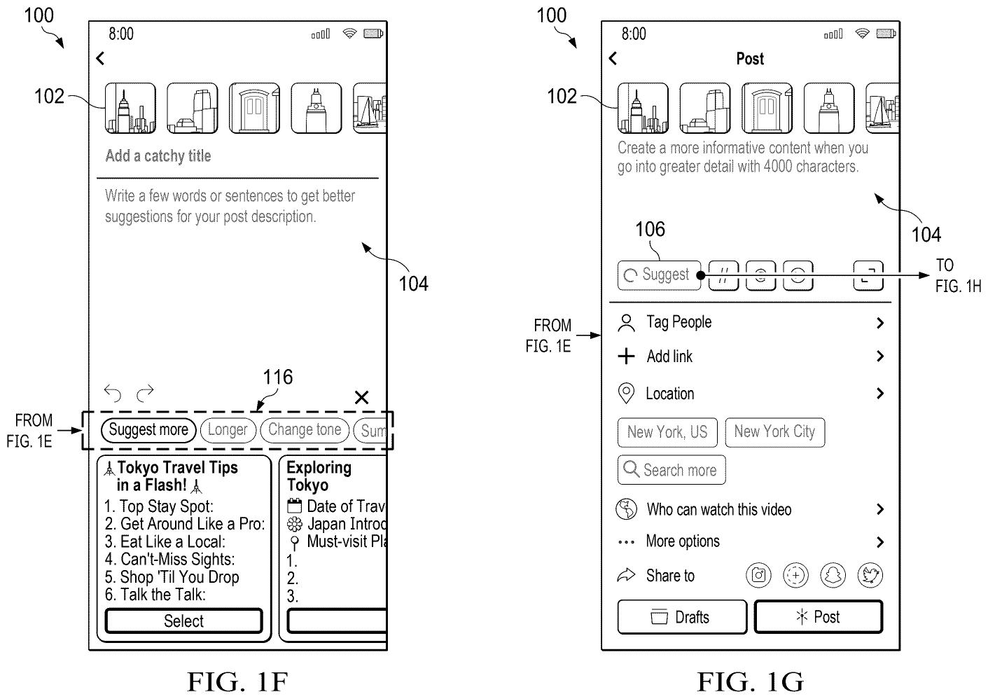

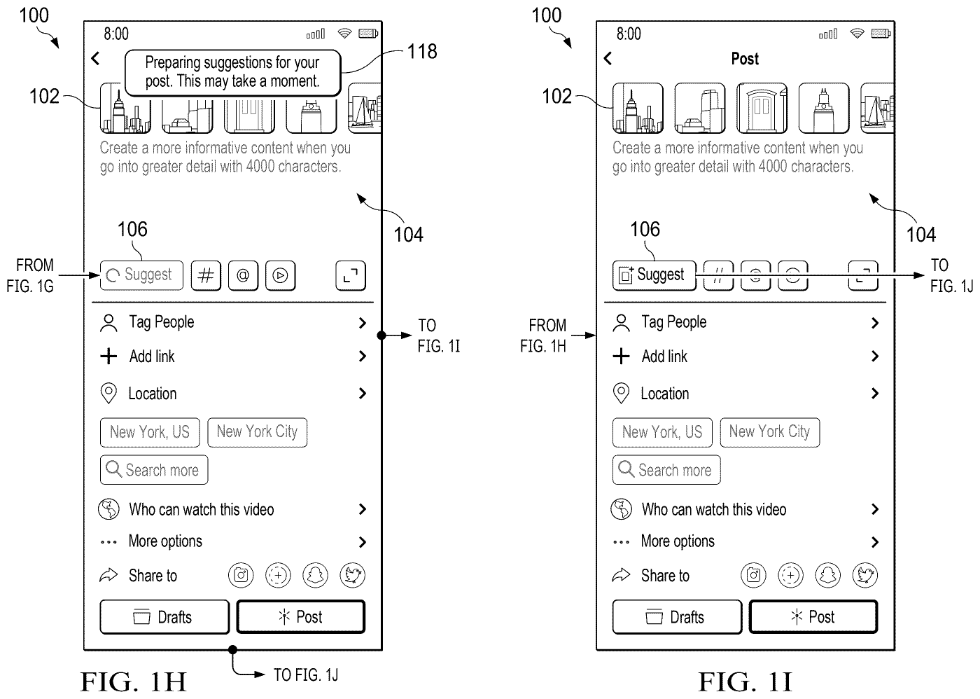

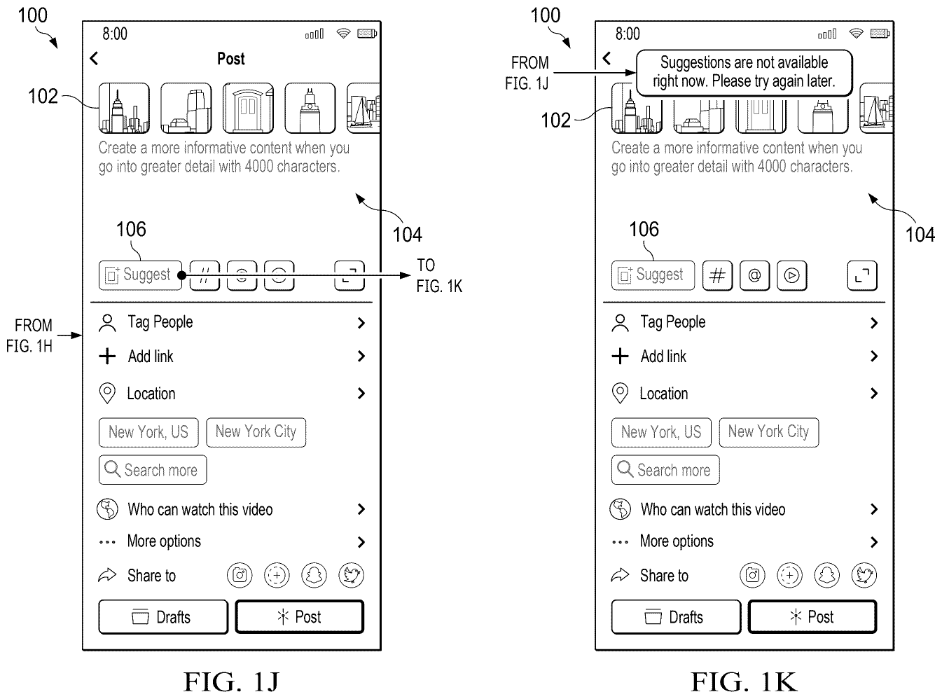

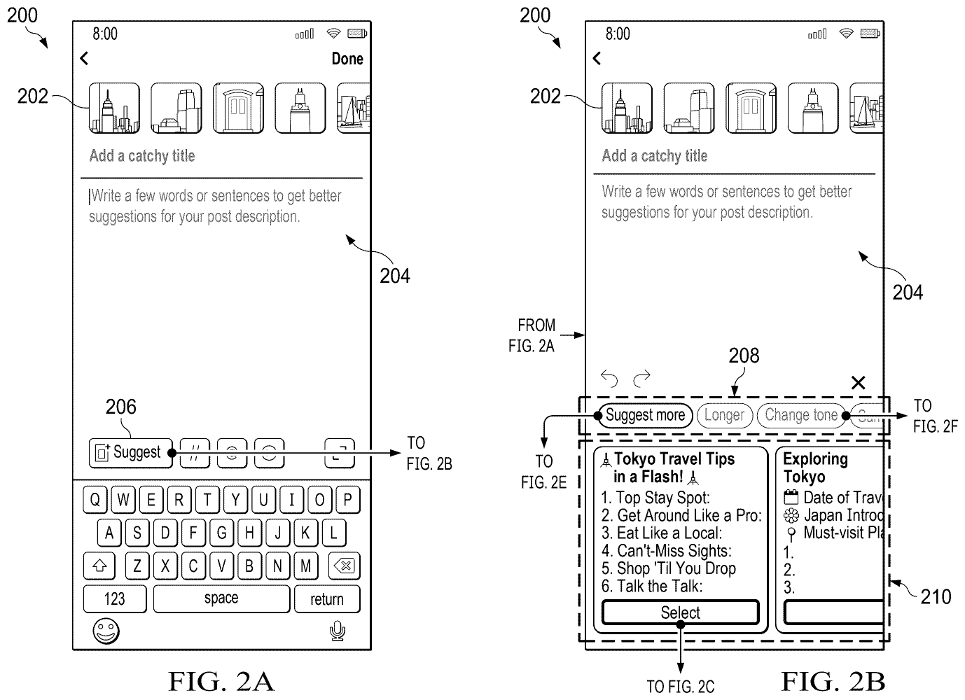

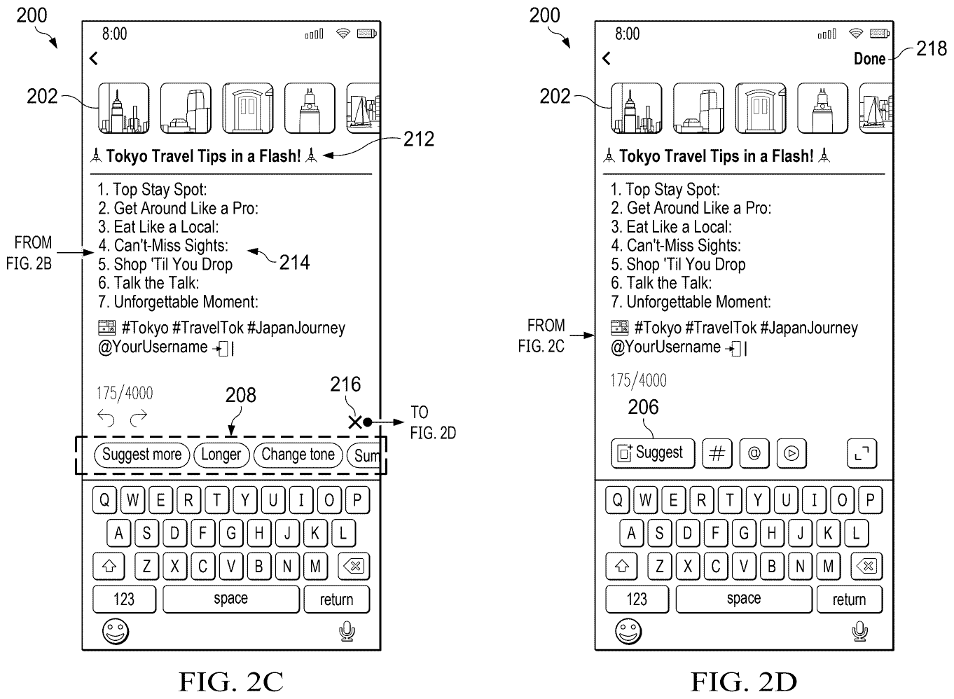

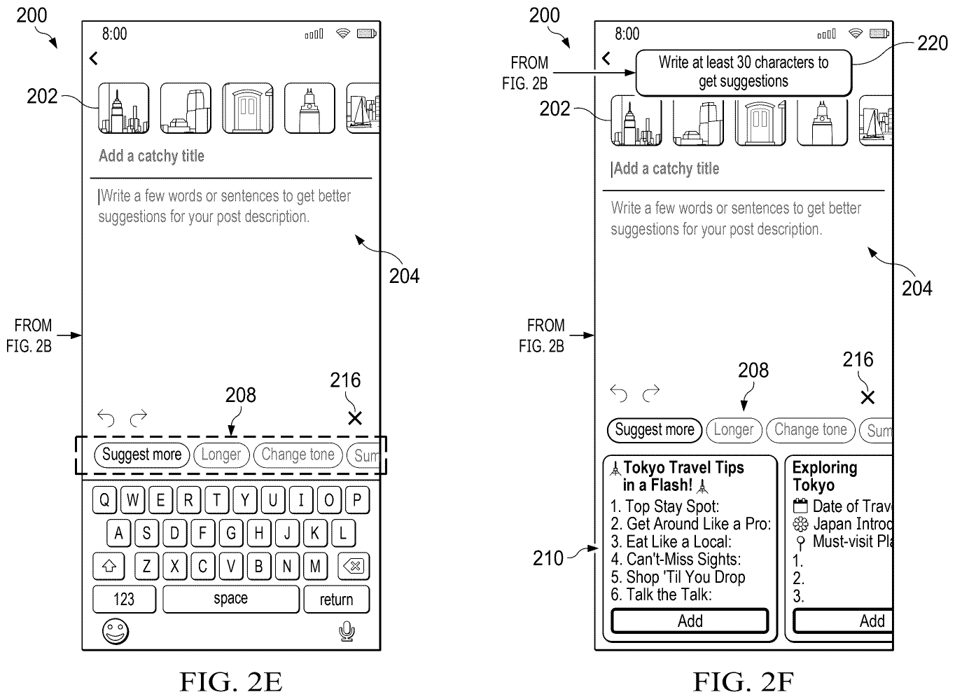

FIGS. 1A-1K illustrate an example user interface (UI) 100 for editing a post, according to one or more implementations of the disclosure. In some implementations, activating a post editing function within an application triggers rendering of UI 100 as illustrated in FIG. 1A, which depicts a post editing page. The post editing page, as part of UI 100, is designed to enhance user engagement and streamline the editing process. The post editing page includes multiple images 102 that users can edit or arrange, a post composing area 104 for text entry, and an interactive element 106 for enabling AI-assisted editing features. In some implementations, the post composing area 104 includes a title field (e.g., the title field 212 of FIG. 2C) and a description field (e.g., the description field 214 of FIG. 2C). Additionally, the post editing page includes various other interactive elements that provide functionalities such as options for adding hashtags (denoted by “#”), tagging other users (denoted by “@”), inserting hyperlinks, and utilizing location services.

In some implementations, interaction with the post editing page, such as tapping the post composing area 104, triggers the activation of a full screen editing mode. The full screen editing mode expands the post composing area 104, enabling the user to compose their post with enhanced visibility and fewer distractions, as depicted in FIG. 1B. The full screen editing mode also includes a title filed 105 that allows a user to include a title for the post. The full-screen feature is designed to accommodate extensive editing tasks and supports the inclusion of detailed text and multimedia. The expanded view facilitates a more focused and immersive user experience, allowing for deeper engagement with the content creation process.

In some implementations, an initial interaction of a user with the interactive element 106 on the post editing page triggers the display of a disclaimer page 108, as depicted in FIG. 1C. The disclaimer page 108 informs the user that activation of the AI-assisted editing functionality is contingent upon their consent. If the user opts to gain further understanding of this functionality by tapping on the “Learn More” element, represented by interactive element 110, a more detailed disclaimer or explanation about the AI-assisted editing features is then presented, as depicted in FIG. 1D. This can ensure that users are fully informed about the nature and implications of the AI tools at their disposal, promoting transparency and informed consent in the utilization of AI technology within the application.

In some implementations, the disclaimer page 108 includes additional interactive elements to facilitate user control over the activation of AI-assisted editing features. In the shown example of FIG. 1C, interactive element 112 is provided to allow users to decline the activation of the AI-assisted editing functionality. Interactive element 114 is included to permit users to consent to enabling the AI-assisted editing functionality. This configuration can ensure that users have clear options to either accept or refuse the use of AI technologies, thereby enhancing user autonomy and consent in the application's operation. These interactive elements are designed to make the decision process straightforward and user-friendly, promoting a transparent interaction model within the application.

In the illustrated embodiment, when a user engages with interactive element 114 to authorize the activation of AI-assisted editing functionality, interactive element 114 transitions its label from an initial state, such as “Get Started,” to a subsequent label that indicates the activation process as demonstrated in FIG. 1E. Following this label change, the AI-assisted editing panel 116 becomes visible, presenting a variety of AI-assisted editing options. As shown in FIG. 1F, these options include, but are not limited to, “Suggest more,” “Longer,” and “Change tone,” allowing users to tailor their content dynamically according to their needs.

In some implementations, when the user engages with interactive element 112 to decline the AI-assisted editing functionality, interactive element 106, which is used to activate the AI-assisted editing features, becomes greyed out, as illustrated in FIG. 1G. This visual change serves as an indication that the AI-assisted editing functionality has been disabled. When the user subsequently taps interactive element 106, a notification 118 appears, informing the user that the AI-assisted editing functionality is set to be activated, as shown in FIG. 1H. Following this interaction, interactive element 106 reverts from being greyed out, signaling that the AI-assisted editing functionality has been reactivated, as depicted in FIG. 1I. This sequence allows users to visually and interactively manage the enabling and disabling of AI editing features, enhancing user control and clarity in the application interface.

In some implementations, when a system malfunction occurs, such as a failure in uploading, the interactive element 106, which is designated for activating the AI-assisted editing functionality, will automatically become greyed out, as depicted in FIG. 1J. This change visually communicates to the user that the AI-assisted editing functionality is temporarily disabled. If the user attempts to engage with the greyed-out interactive element 106, a notification 120 will be presented, informing the user that the AI-assisted editing functionality is currently unavailable, as shown in FIG. 1K. This feature ensures that users are promptly made aware of any disruptions in service, maintaining transparency and managing user expectations effectively.

FIGS. 2A-2F illustrate an example UI 200 for editing a post, according to one or more implementations of the disclosure.

FIG. 2A illustrates UI 200 configured as a post editing page, including multiple images 202 for user modification or arrangement, a post composing area 204 for text entry, and an interactive element 206 designed to activate AI-assisted editing functionalities. Upon user activation of element 206, an AI-assisted editing panel 208 is displayed, offering various editing options such as “Suggest more,” “Longer,” and “Change tone,” as shown in FIG. 2B. In some examples, when no textual content is inputted by the user, only the “Suggest more” option is shown as available for user interaction, and the other options are greyed out, indicating that they are not currently available.

In addition to the AI-assisted editing panel 208, one or more suggested content versions 210 for the post are also provided in the post editing page. In some examples, the suggested content versions 210 can be generated by an AI model based solely on the images 202. Each suggested content version includes an associated interactive element labeled “Select,” enabling the user to choose their preferred content version.

Selecting a suggested content version 210 populates it into the post composing area 204, which includes fields for the title and description, as shown in FIG. 2C. Users can terminate the AI-assisted editing session by tapping an interactive element 216, marked “X,” as depicted in FIGS. 2C and 2D. Subsequently, the AI-assisted editing panel 208 vanishes, and the element 206 for reactivating AI features becomes accessible again. Users may finalize their post edits by tapping the “Done” button 218, as indicated in FIG. 2D.

In some implementations, users have the option to hide the suggested content 210 by tapping the “suggest more” button within panel 208 in FIG. 2B or by interacting with the post composing area 204, as demonstrated in FIG. 2E.

As shown in FIG. 2B, when the user input fewer characters than a predetermined threshold (e.g., 30 characters), certain options within the AI-assisted editing panel 208 will be greyed out, signaling their deactivation. If a user attempts to select any disabled option from panel 208, a notification 220 will appear, advising that a minimum of the threshold character count is required to activate the disabled editing options, as illustrated in FIG. 2F. This functionality ensures that the editing tools are only activated when there is sufficient text to support meaningful edits, thus maintaining the quality and relevance of the AI-assisted enhancements.

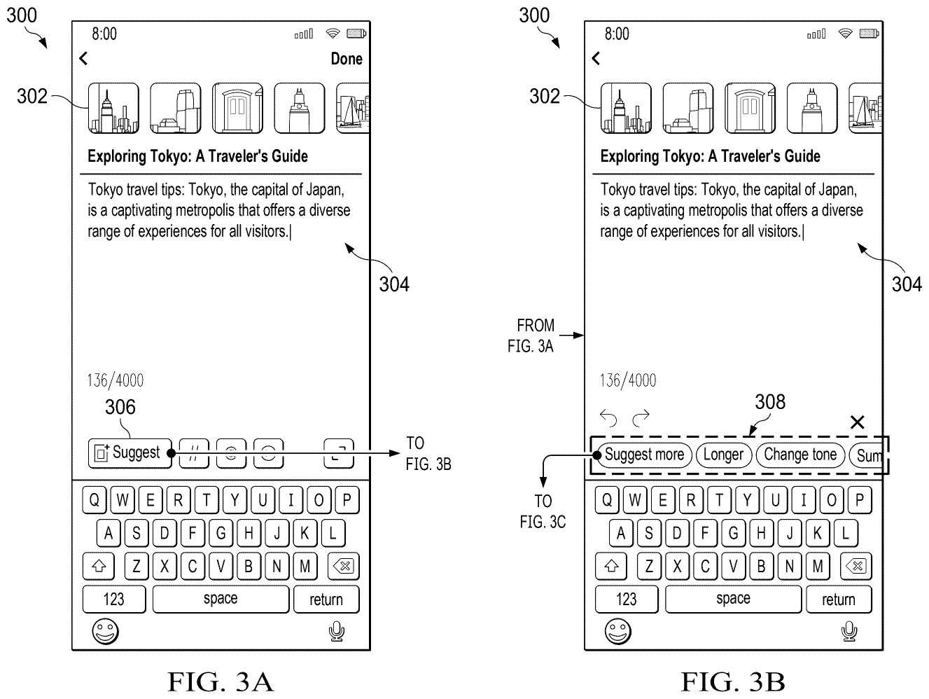

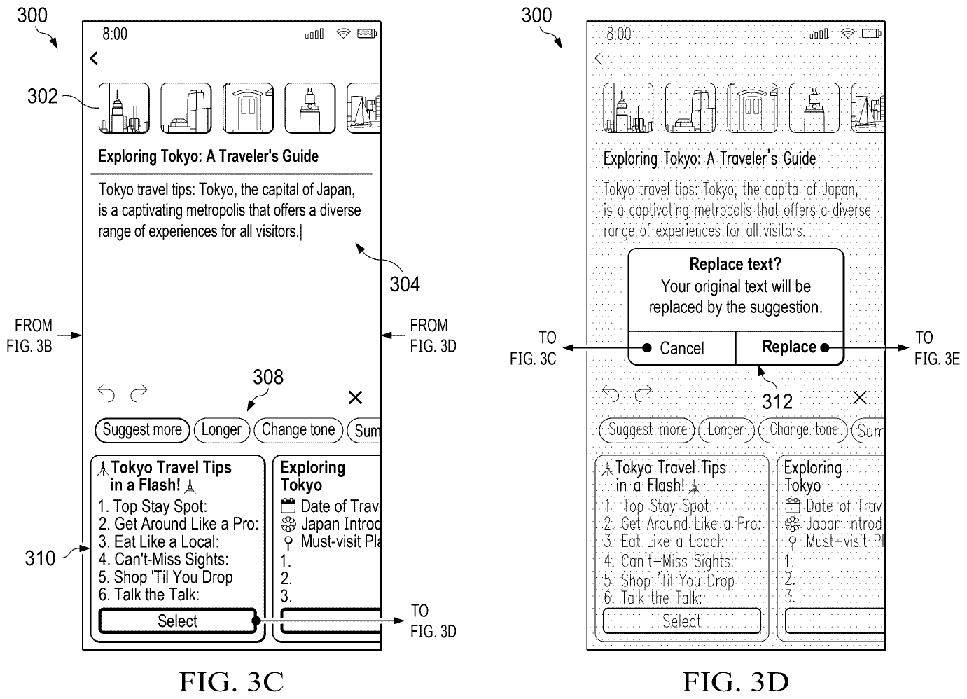

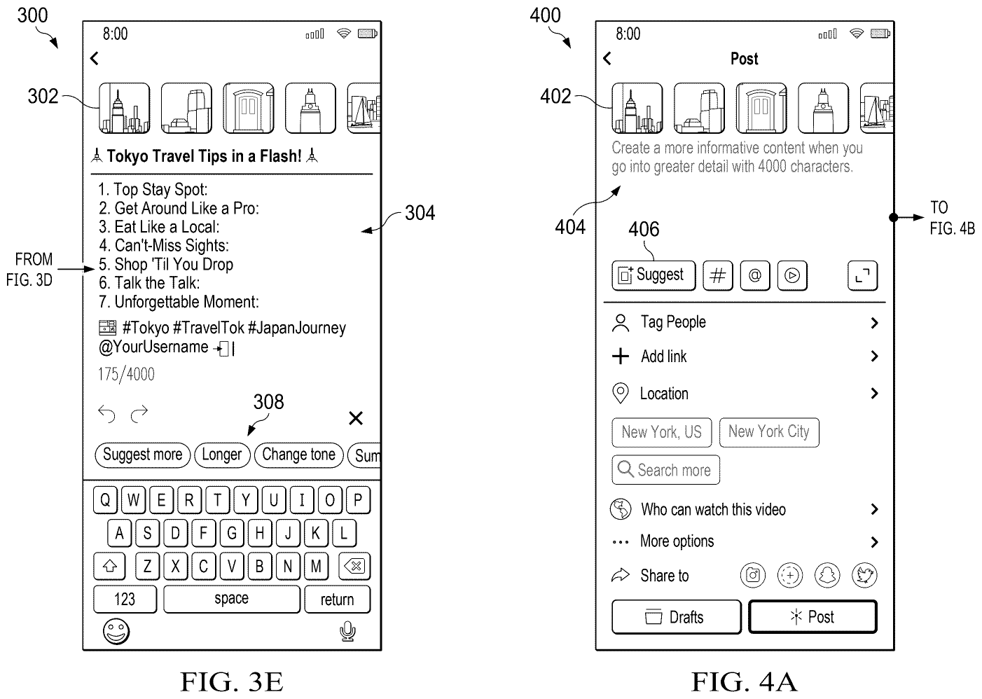

FIGS. 3A-3E illustrate an example UI 300 for editing a post, according to one or more implementations of the disclosure.

FIG. 3A illustrates UI 300 configured as a post editing page, including multiple images 302 for user customization, a post composing area 304 for text entry, and an interactive element 306 designed to activate AI-assisted editing features. In the example shown, the user has already inputted some text into the post composing area 304. In scenarios where the user input exceeds a predefined threshold (e.g., 30 characters), tapping the interactive element 306 will reveal the AI-assisted editing panel 308, which offers a range of editing options including, but not limited to, “Suggest more,” “Longer,” and “Change tone,” as illustrated in FIG. 3B. In the shown example, all options within the AI-assisted editing panel 308 are displayed as available for user interaction.

Upon selection of the “suggest more” option from the AI-assisted editing panel 308, multiple suggested content versions 310 for the post are shown beneath the panel 308. Each version is accompanied by an interactive element labeled “Select,” which allows users to choose their preferred content version, as depicted in FIG. 3C. If a user selects one of these content versions 310, an alert 312 is generated, prompting the user to decide whether to replace the existing post content with the chosen version 310 or to cancel the selection, as shown in FIG. 3D. If the user opts to replace the existing content, the selected version 310 will update the text in the post composing area 304, as illustrated in FIG. 3E. This feature enhances user control and flexibility, allowing for dynamic content updates based on AI-generated suggestions while respecting user decisions and existing content.

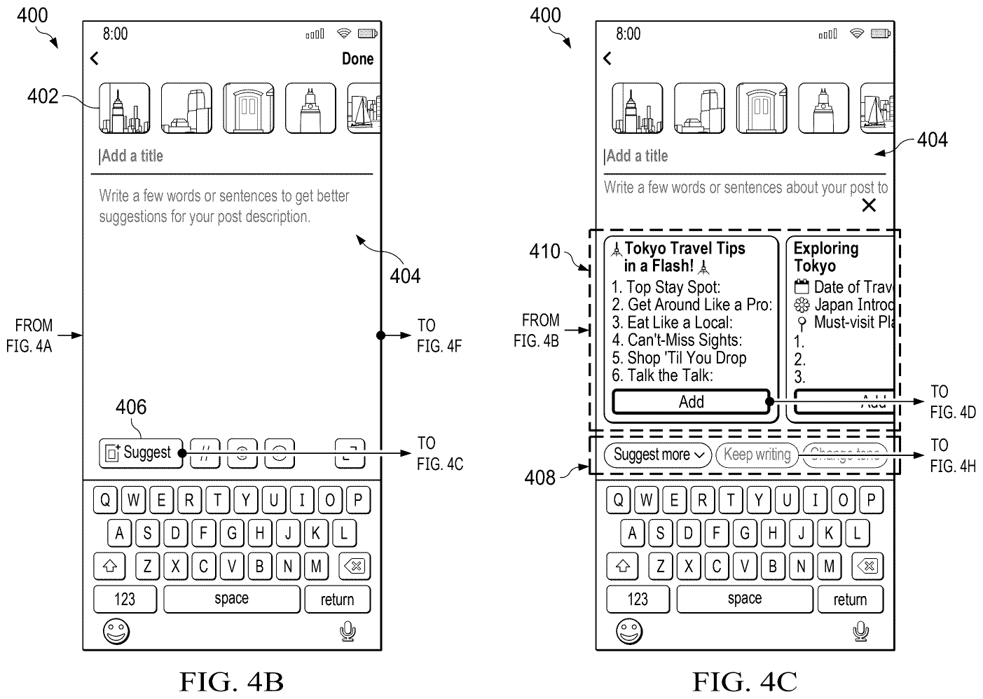

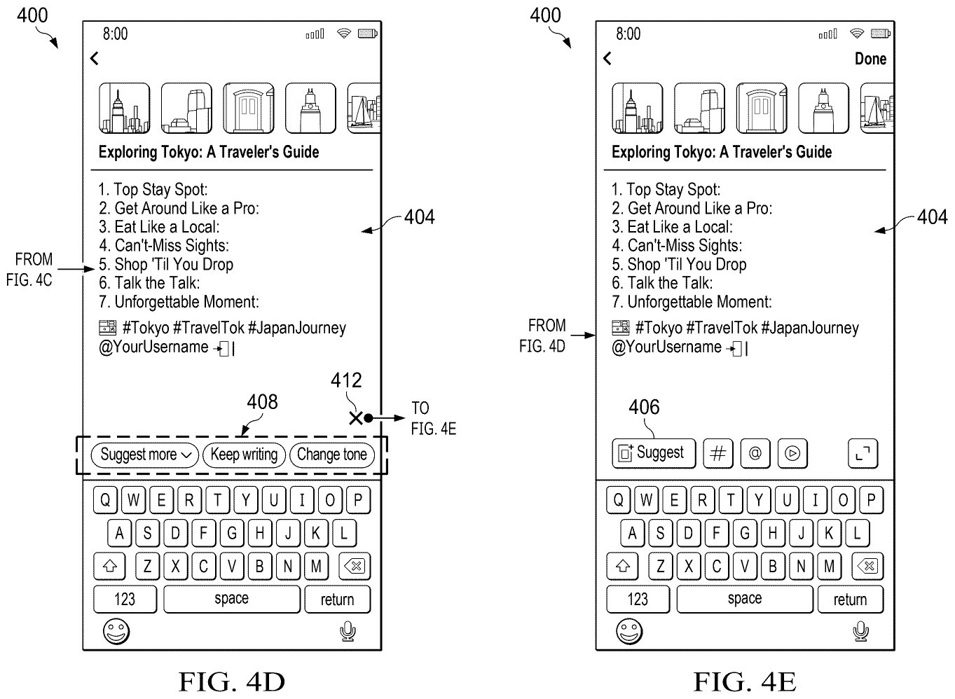

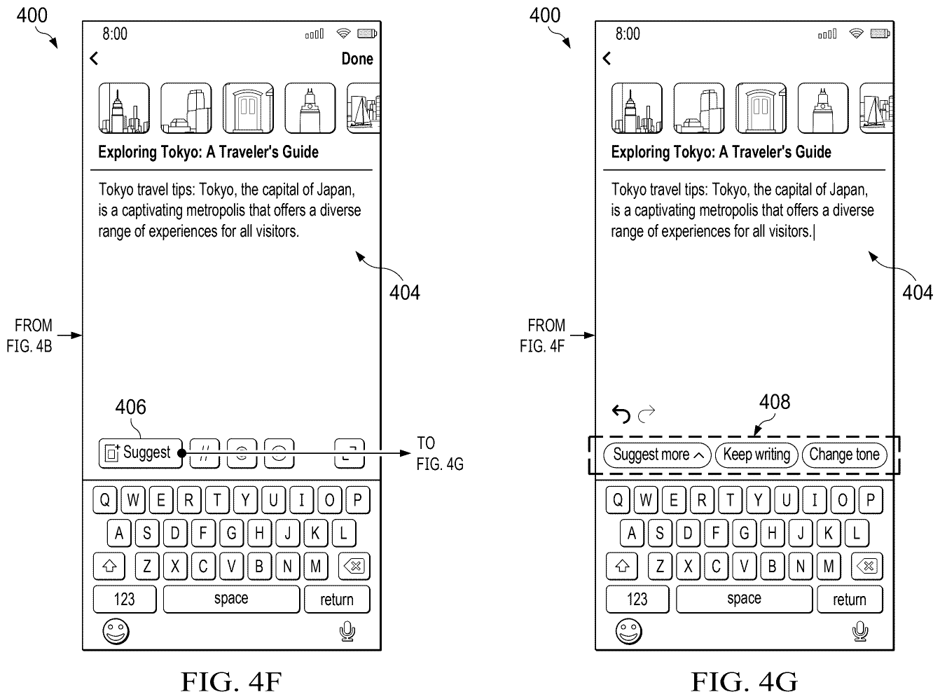

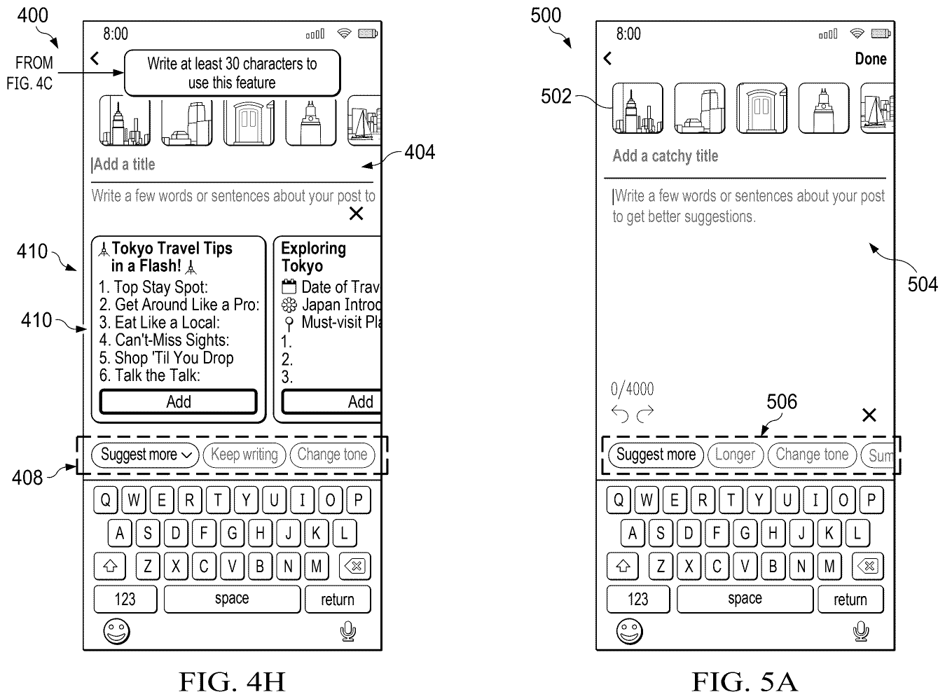

FIGS. 4A-4H illustrate an example UI 400 for editing a post, according to one or more implementations of the disclosure.

In some implementations, activating a post editing function within an application triggers the rendering of UI 400 as illustrated in FIG. 4A, which depicts a post editing page. The post editing page includes multiple images 402 that users can edit or arrange, a post composing area 404 for text entry, and an interactive element 406 for enabling AI-assisted editing features. Additionally, the post editing page includes various other interactive elements that enhance the functionality and user interaction, such as options for adding hashtags, ‘@’ mentions, tagging other users, inserting hyperlinks, and utilizing location services.

In some implementations, interacting with the post editing page, such as tapping the post composing area 404, initiates a transition to a full screen editing mode. The full screen editing mode enlarges the post composing area, enhancing the user's ability to compose posts with increased visibility and minimal distractions, as shown in FIG. 4B. The full-screen functionality is tailored to support extensive editing tasks, including the integration of detailed text and multimedia content. The expanded view is designed to provide a more focused and immersive editing experience, fostering deeper user engagement with the content creation process.

Activation of the interactive element 406 reveals the AI-assisted editing panel 408, featuring options such as “Suggest more,” “Longer,” and “Change tone,” as depicted in FIG. 4C. In scenarios where no text or insufficient text (below a specified threshold) is entered, only the “Suggest more” option is active, with other options in the AI-assisted editing panel 408 being temporarily inaccessible (greyed out). The keyboard remains visible and accessible, enhancing user convenience. Additionally, multiple content versions 410 are displayed above the AI-assisted editing panel 408, each associated with an “Add” element that allows users to select and incorporate these versions into their posts.

Selecting a content version 410 via its associated “Add” element populates this version into the post composing area 404. As illustrated in FIG. 4D, when the post composing area 404 contains text exceeding a certain threshold, all editing options in the AI-assisted editing panel 408 become accessible. An interactive exit element 412, marked as “X,” also appears, providing a straightforward method for users to exit AI-assisted editing. Tapping the “X” element makes the editing panel 412 disappear, restoring the visibility of the interactive element 406 for reactivating AI-assisted editing features, as shown in FIG. 4E.

Further examples include scenarios depicted in FIGS. 4F and 4G, where entering text above a designated threshold and tapping the interactive element 406 brings forth the AI-assisted editing panel 408 with all editing options enabled. In some examples, as shown in FIG. 4H, if the text entered is below the threshold and the user activates the AI-assisted editing panel 408 via element 406, only the “Suggest more” option will be available, reflecting adaptive functionality based on text input levels. This adaptive approach ensures that editing tools are appropriately matched to the content volume, optimizing the editing experience.

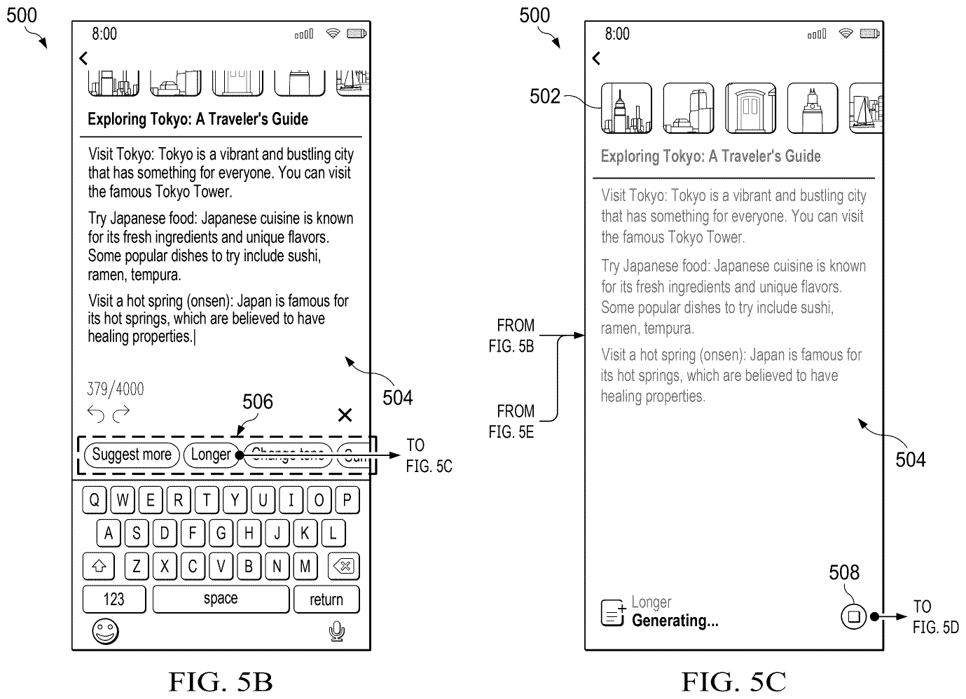

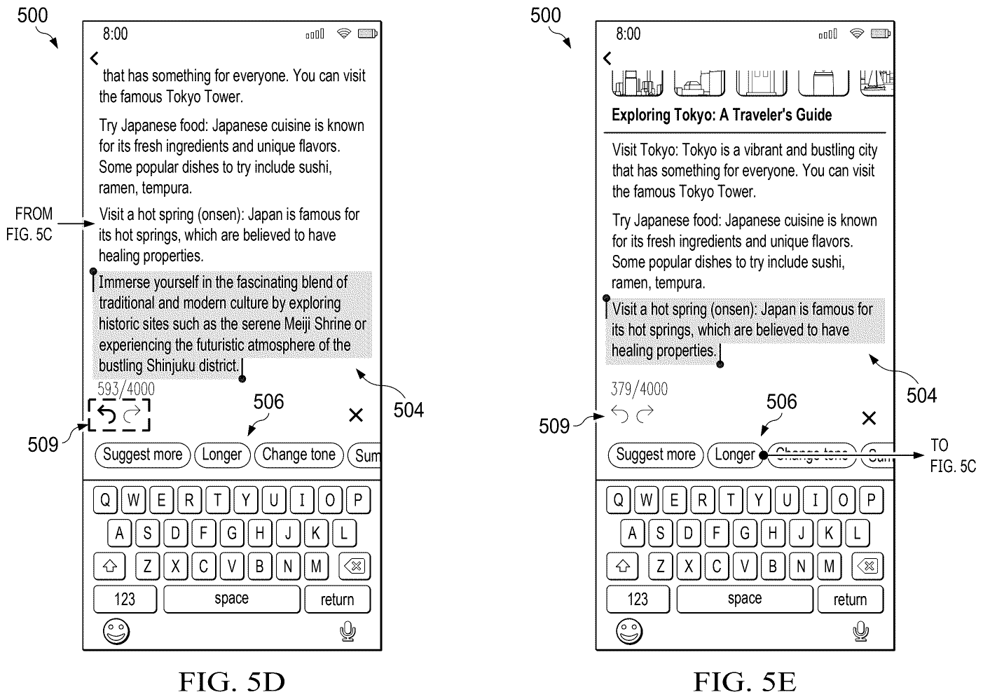

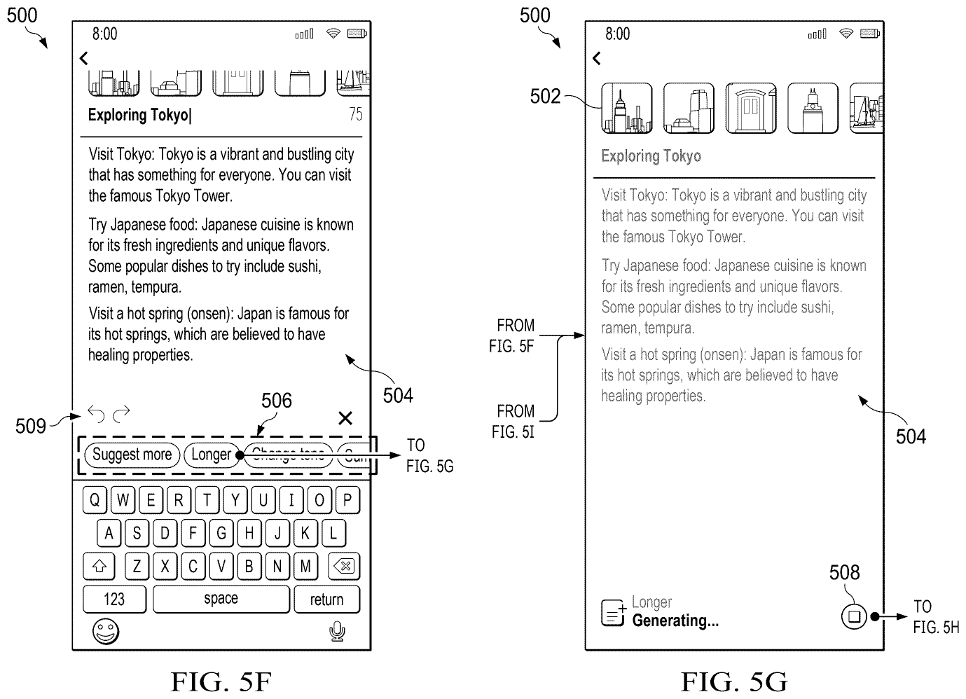

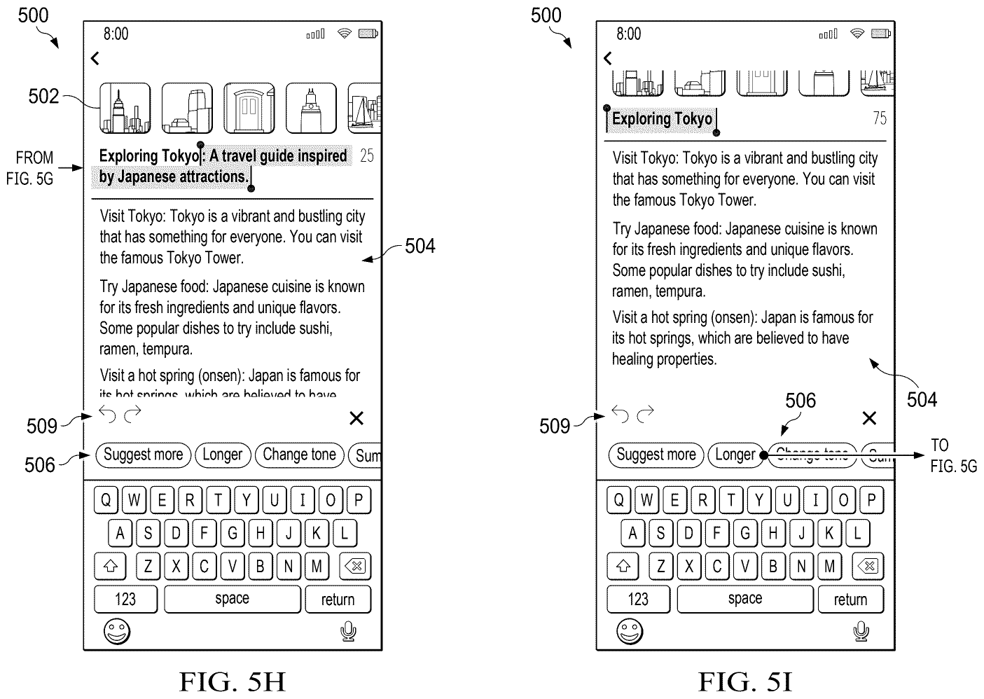

FIGS. 5A-5I illustrate an example UI 500 for editing a post, according to one or more implementations of the disclosure.

FIG. 5A illustrates UI 500 configured as a post editing page. The post editing page includes multiple images 502, a post composing area 504, and an AI-assisted editing panel 506. The editing panel 506 includes options such as “Suggest more,” “Longer,” and “Change tone.” In some implementations, when the number of characters entered by the user falls below a specified threshold, only the “Suggest more” option is made accessible, while the other options are temporarily disabled and displayed as greyed out.

In some implementations, when the character count in the post composing area 504 exceeds the threshold, all options within the AI-assisted editing panel 506 become accessible, as depicted in FIG. 5B. This feature ensures that more complex editing tools are only unlocked when sufficient text is present, enhancing their relevance and effectiveness.

In some implementations, post composing area 504 includes a title field and a description field. In some examples, when a user positions the cursor at a particular location within the description field and selects the “Longer” option from the AI-assisted editing panel 506, the system will automatically continue generating text based on the content preceding the cursor position and the images 502, as shown in FIG. 5C. Upon activation of this “Longer” option, the post composing area 504 is temporarily disabled, the editing panel 506 and keyboard are hidden, and a loading status is displayed, indicating ongoing content generation.

During the display of the loading status for the “Longer” option, an interactive element 508 is also presented, enabling the user to exit this editing mode. Tapping this element 508 concludes the extension process, revealing the AI-generated text at the previous cursor location. In some examples, without users terminating the generation process, and after the system completes the generation, the post composing area 504 is subsequently re-enabled, and the AI-assisted editing panel 506 becomes accessible again, as illustrated in FIG. 5D. In some implementations, the newly added content is automatically highlighted, making it easy for users to review and modify as needed. This system can enhance user interaction by providing dynamic content generation tools while maintaining user control and flexibility.

In some implementations, as illustrated in FIG. 5D, the post editing page features interactive elements 509 that enables users to toggle between various versions of content previously generated via AI-assisted features and subsequently confirmed for inclusion in the post composing area 504. This version control functionality facilitates navigation among different revisions of the post content, allowing users to review and compare multiple iterations of their work seamlessly.

In some implementations, users are provided the capability to select a specific segment of text within the description field of the post composing area 504 and utilize the “Longer” option to extend the composition based on the selected text, as shown in FIG. 5E. In some examples, the system not only considers the selected text but also integrates the preceding content and associated images 502 from the post to generate additional text. This functionality allows for contextual continuation of the post content, enhancing the coherence and relevance of the extended text in relation to the original content and visual elements. This feature can be useful for users who wish to develop more detailed narratives or explanations seamlessly within their posts.

In some examples, the system is capable of automatically continuing the composition of a title within the title field of the post composing area 504, based on the initial user input. In some examples, when users have entered a sufficient number of characters in the description field of the post composing area 504, exceeding a predetermined threshold, all available options can be unlocked in the AI-assisted editing panel 506, as illustrated in FIG. 5F. When a user positions the cursor at the end of the existing title content and selects the “Longer” option from the editing panel 506, the system initiates the automatic generation of additional title content. As depicted in FIG. 5G, upon activation of the “Longer” option, the post composing area 504 is temporarily disabled, and both the editing panel 506 and the keyboard are concealed to present a loading status. This status serves as an indicator of ongoing content generation, ensuring users are aware of the system's active engagement in extending the title based on the context provided by the user.

During the display of the loading status for the “Longer” option, an interactive element 508 is also presented, enabling the user to exit this editing mode. Tapping this element 508 concludes the extension process, revealing the AI-generated text at the previous cursor location in the title field. In some examples, without users terminating the generation process, and after the system completes the generation, the post composing area 504 is subsequently re-enabled, and the AI-assisted editing panel 506 becomes accessible again, as illustrated in FIG. 5H. In some implementations, the newly added content in the title field is automatically highlighted, making it easy for users to review and modify as needed.

In some examples, users can select either a portion or the entirety of the title within the post composing area 504 to facilitate the continuation of title composition, as demonstrated in FIG. 5I. In some implementations, the system utilizes the selected title segment, the content preceding the selected segment, and associated images from the post to generate additional title content. This feature can allow for a contextual and coherent extension of the title, ensuring that the additional content is seamlessly integrated and relevant to the existing title and visual elements. This capability can enhance the flexibility and creativity of title generation, providing users with powerful tools to refine and expand their post titles effectively.

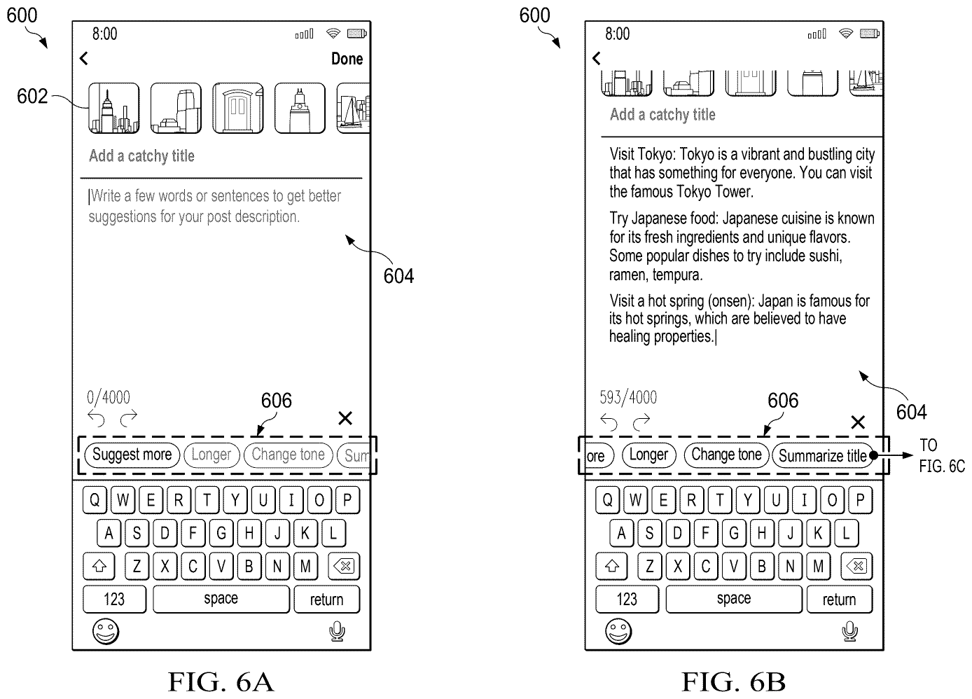

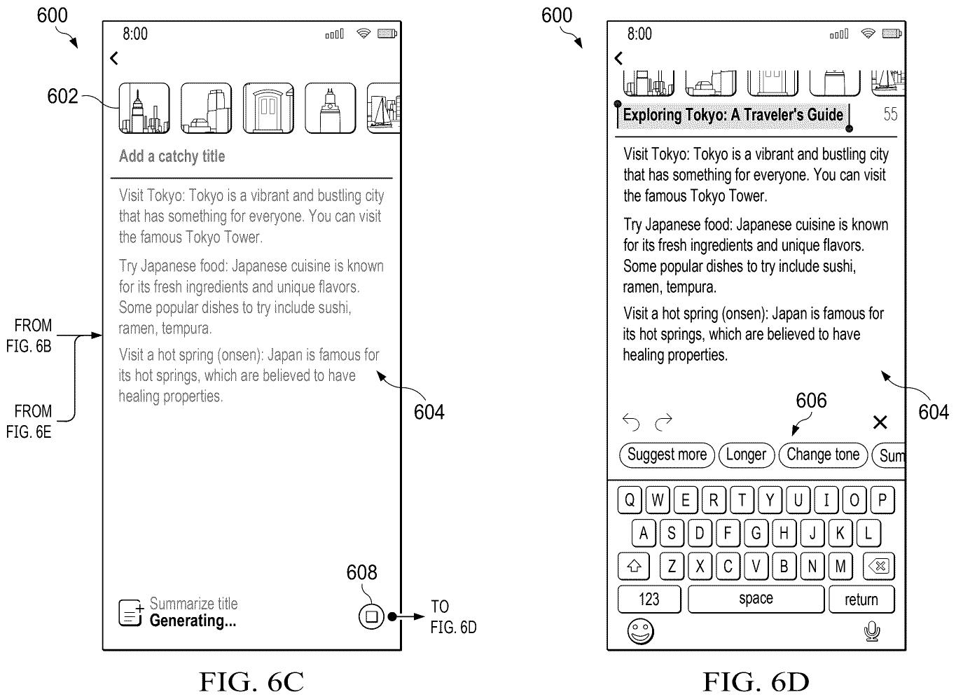

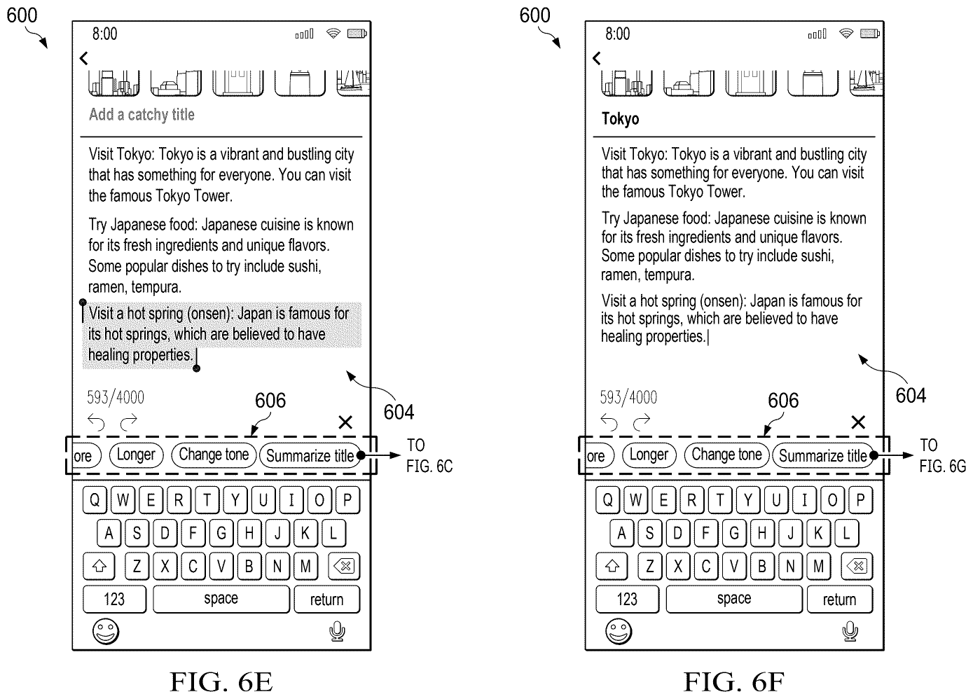

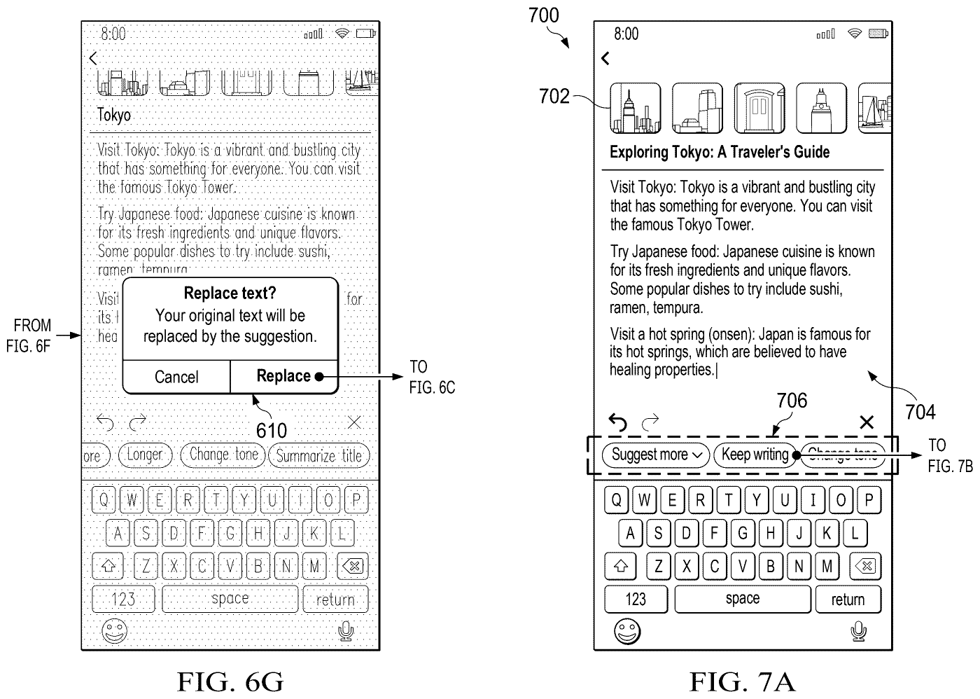

FIGS. 6A-6G illustrate an example UI 600 for editing a post, according to one or more implementations of the disclosure.

FIG. 6A illustrates UI 600 configured as a post editing page. The post editing page includes multiple images 602, a post composing area 604, and an AI-assisted editing panel 606. The editing panel 606 includes options such as “Suggest more,” “Longer,” “Change tone,” and “Summarize title.” In some implementations, when the number of characters entered by the user falls below a specified threshold, only the “Suggest more” option is made accessible, while the other options are temporarily disabled and displayed as greyed out.

In some implementations, when the content entered by a user in the description field of the post composing area 604 exceeds a specified threshold and no title is provided in the title field, users may select the “Summarize title” option from the editing panel 606 to initiate automatic title generation, as depicted in FIG. 6B.

Upon selection of the “Summarize title” option, the system begins the process of automatic title creation. As shown in FIG. 6C, activating the “Summarize title” option results in the temporary disabling of the post composing area 604, and the concealment of both the editing panel 606 and the keyboard, with a loading status displayed to indicate ongoing title generation.

During the loading phase, an interactive element 608 is displayed, providing users with the option to exit this mode. Engaging this element 608 terminates the title generation process and reveals the AI-generated title in the title field. In some examples, without users terminating the generation process, and after the system completes the title generation, the post composing area 604 is subsequently reactivated, and access to the AI-assisted editing panel 606 is restored, as illustrated in FIG. 6D. The newly generated title content can be highlighted automatically, facilitating easy review and potential modification by the user.

Additionally, users may select specific segments of the description and utilize the “Summarize title” option to generate a title, as shown in FIG. 6E. In some examples, the system can disregard the selected description content and generate the title based on the entirety of the description and associated images 602, enhancing the flexibility of the title generation process.

In scenarios where a title is already present, and users activate the “Summarize title” option to request a new title, as illustrated in FIGS. 6F and 6G, the system will provide a notification 610, notifying users that the existing title will be replaced with the new one. Users are then presented with options to either confirm or decline this replacement, ensuring user control over the content modification process and maintaining clarity in content management.

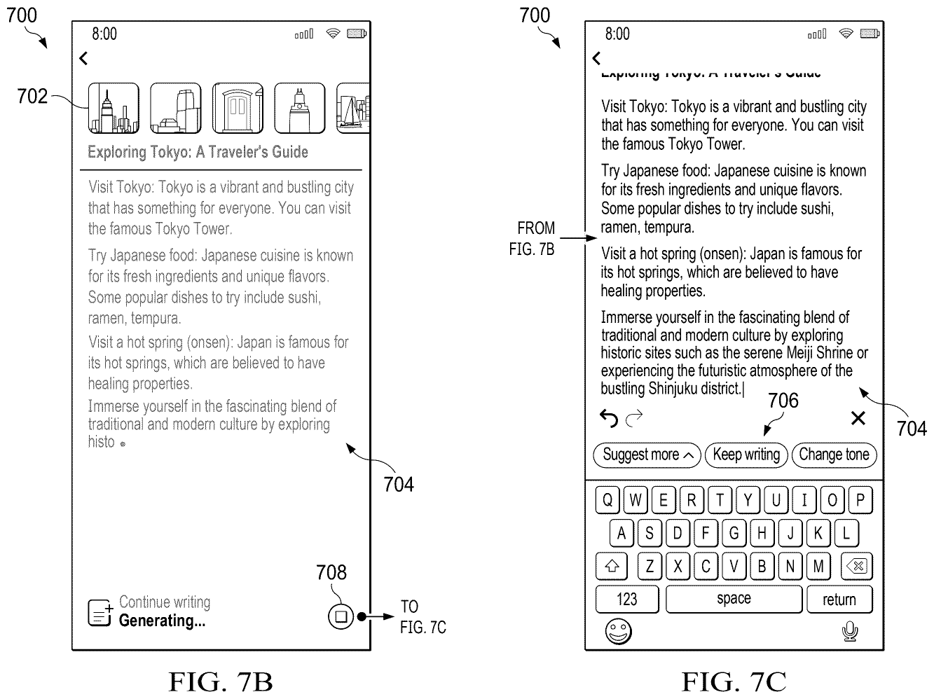

FIGS. 7A-7C illustrate an example UI 700 for editing a post, according to one or more implementations of the disclosure.

FIG. 7A illustrates UI 700 configured as a post editing page. The post editing page includes multiple images 702, a post composing area 704, and an AI-assisted editing panel 706. The editing panel 706 includes options such as “Suggest more,” “Keep writing,” and “Change tone.” In some examples, as shown, when the number of characters in the description field of post composing area 704 exceed a specified threshold, all editing options in the editing panel 706 are made accessible.

In some examples, selecting the “Keep writing” option from the editing panel 706 enables the system to automatically continue composing the post based on existing inputs in the post composing area 704 and associated images 702. For example, upon activation of this option, the system can commence the generation of additional content, taking into account the existing title, content prior to the cursor's position, and the images 702.

The activation of the “Keep writing” option leads to the temporary deactivation of the post composing area 704, and the concurrent concealment of the editing panel 706 and the keyboard. A loading status is displayed during this time to inform users of the ongoing content generation process, as depicted in FIG. 7B.

An interactive element 708 is also presented during the loading phase, providing users with the ability to exit this automatic writing mode. Engaging this element 708 halts the content generation, revealing the newly created AI-generated content within the description field. If the generation process is not manually terminated by the user and completes successfully, the post composing area 704 is re-enabled, and access to the AI-assisted editing panel 706 is reinstated, as illustrated in FIG. 7C.

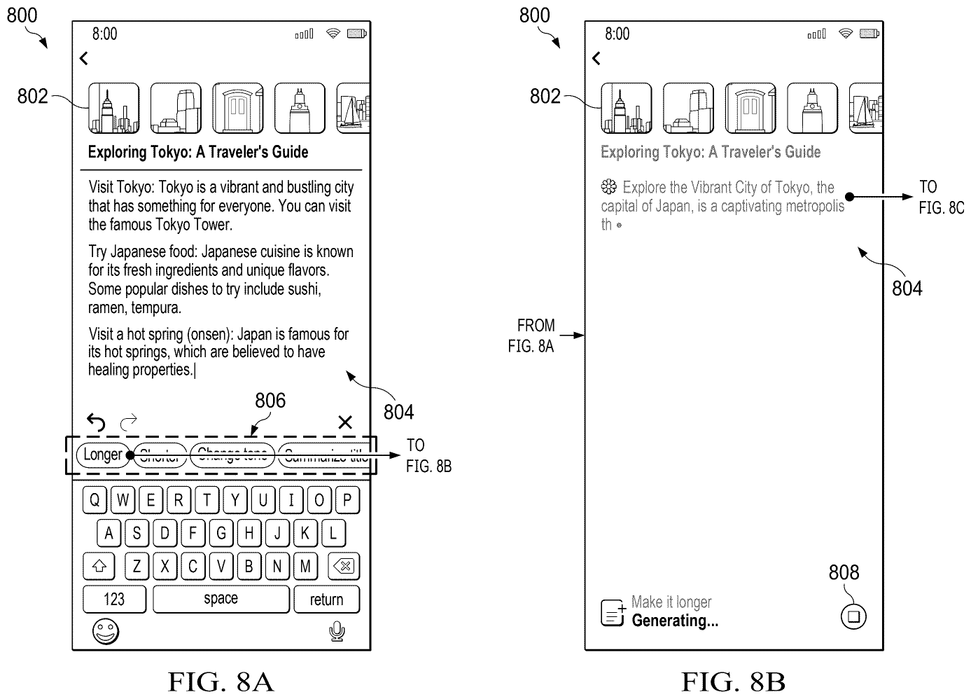

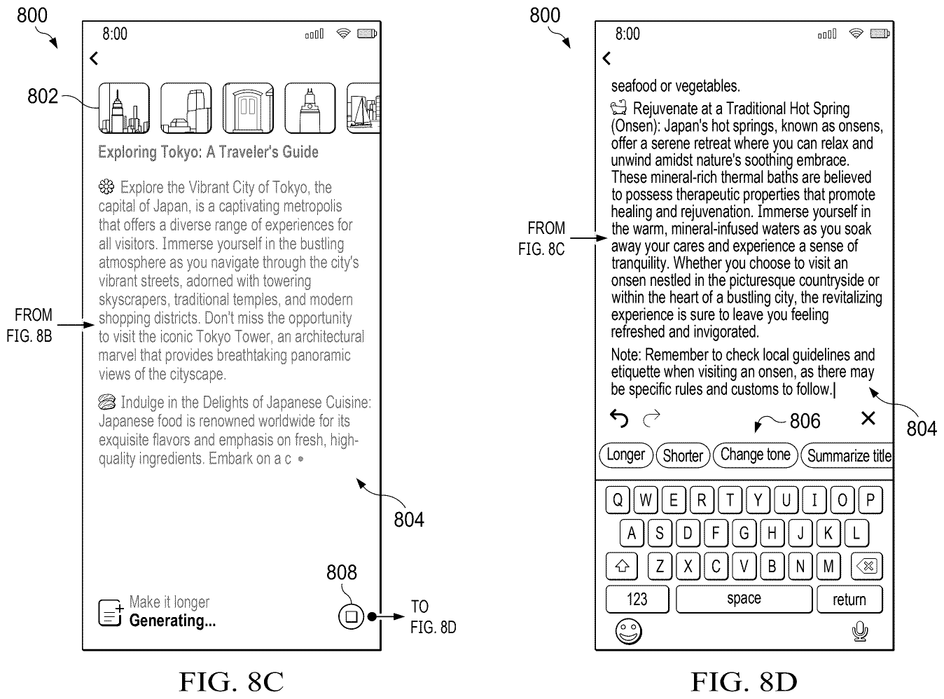

FIGS. 8A-8D illustrate an example UI 800 for editing a post, according to one or more implementations of the disclosure.

FIG. 8A illustrates UI 800 configured as a post editing page. The post editing page includes multiple images 802, a post composing area 804, and an AI-assisted editing panel 806. The editing panel 806 includes options such as “Longer,” “Shorter,” “Change tone,” and “Summarize title.” In some examples, as shown, when the number of characters in the description field of post composing area 804 exceed a specified threshold, all editing options in the editing panel 806 are made accessible.

In some examples, when users select the “Longer” option from the editing panel 806 to extend the description of a post, this selection triggers the system to automatically continue the composition based on inputs already present in the post composing area 804 and related images 802. For instance, upon activation, the system begins generating additional content that considers the current title, the content preceding the cursor's location, and the images 802.

Activating the “Longer” option results in the temporary disabling of the post composing area 804, along with the concealment of both the editing panel 806 and the keyboard. During this period, a loading status is displayed to keep users informed about the active content generation process, as shown in FIGS. 8B and 8C.

As illustrated in FIGS. 8B and 8C, while the loading status is visible, the system may also display the progression of content generation on the post editing page. This feature provides users with real-time feedback on the content being generated, enhancing transparency and engagement during the automatic composition process.

In some examples, users are afforded the flexibility to terminate the generation process at any point. By tapping an interactive element 808, users can halt the process, and the AI-generated content will then be displayed. In some examples, if the generation process concludes without manual interruption and is successful, the post composing area 804 is reactivated, and access to the AI-assisted editing panel 806 is restored, as depicted in FIG. 8D. This approach ensures that users maintain control over the content generation, allowing for dynamic interaction with the editing process.

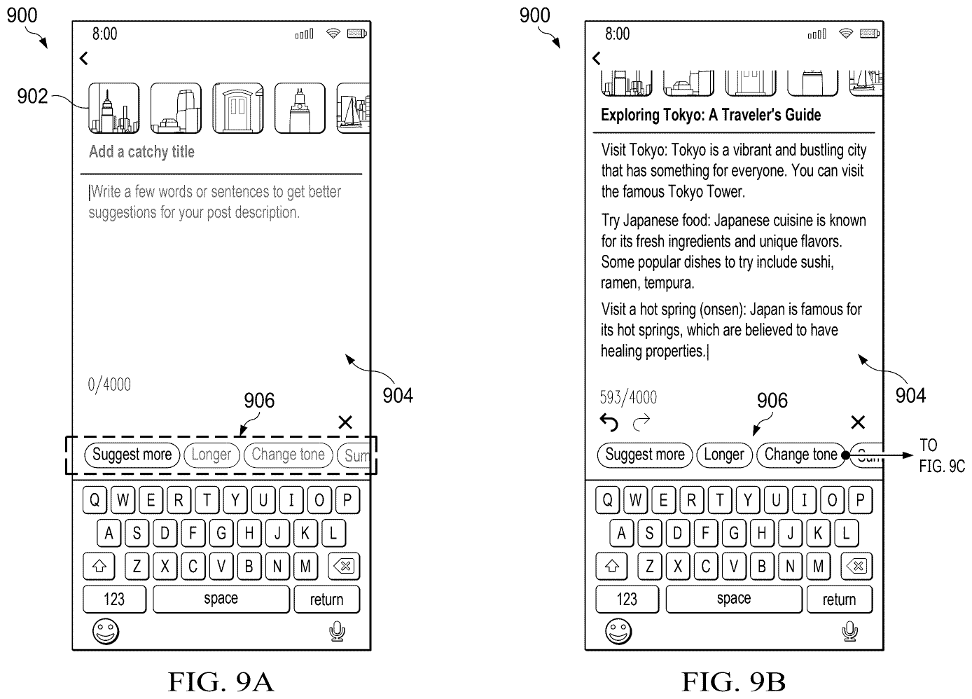

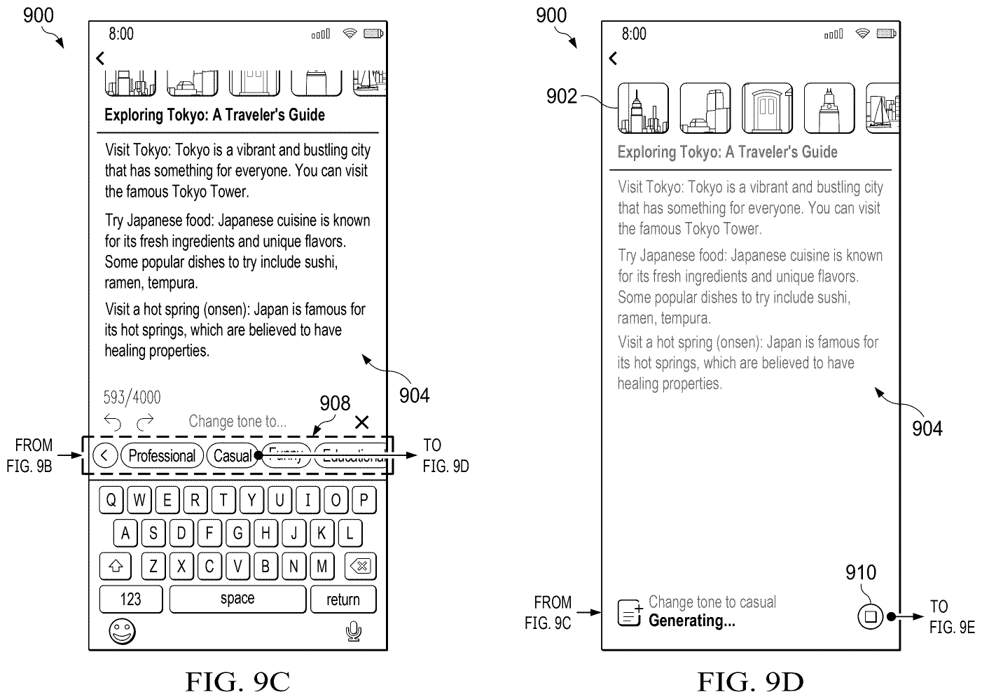

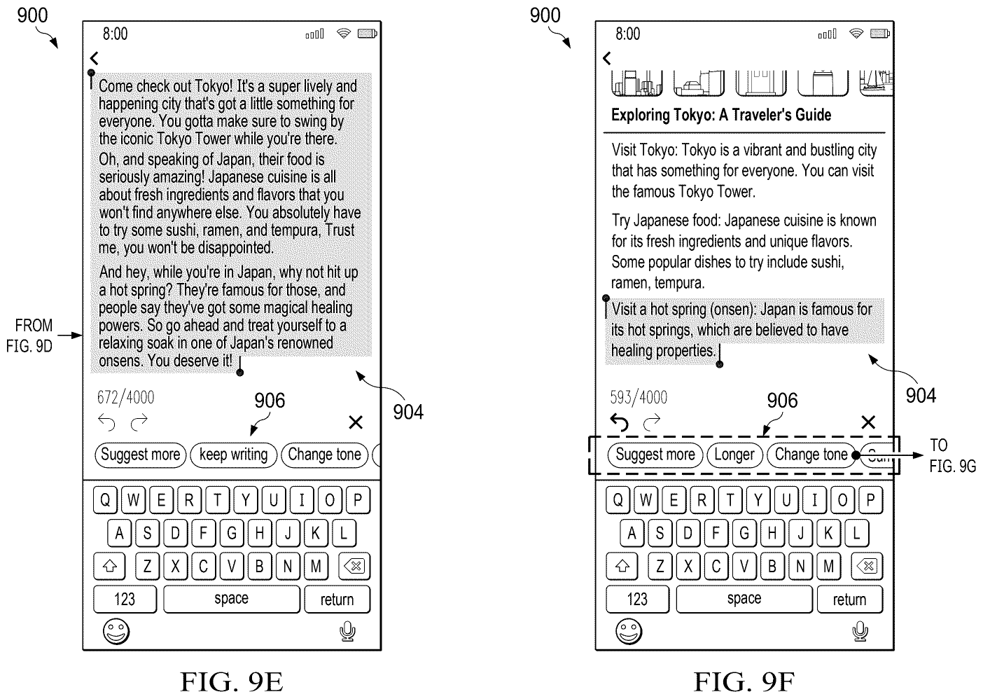

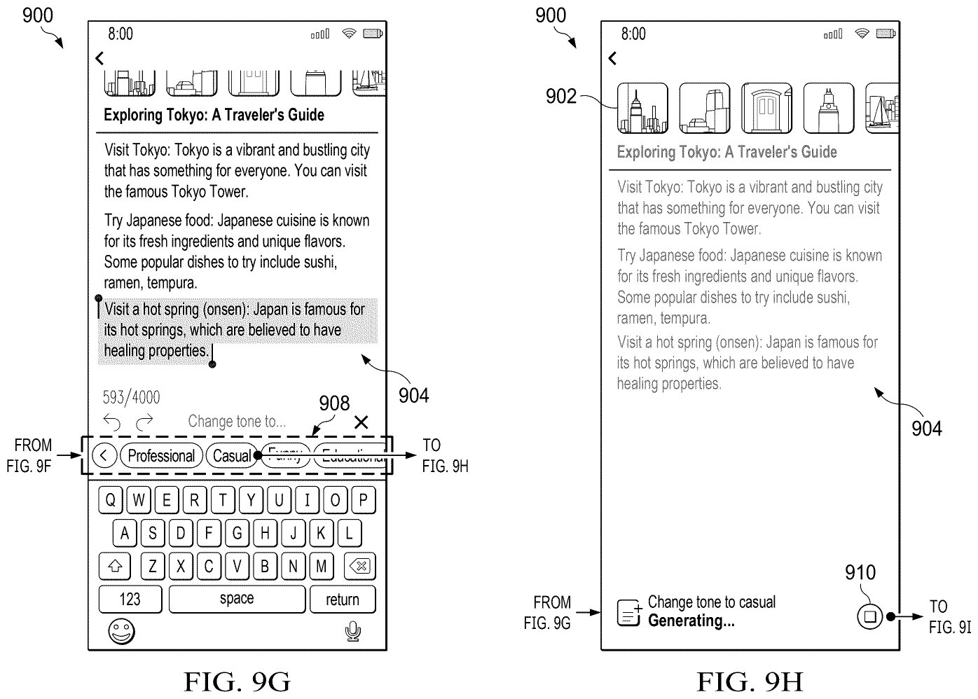

FIGS. 9A-9I illustrate an example UI 900 for editing a post, according to one or more implementations of the disclosure.

FIG. 9A illustrates UI 900 configured as a post editing page. The post editing page includes multiple images 902, a post composing area 904, and an AI-assisted editing panel 906. The AI-assisted editing panel 906 includes various editing options like “Suggest more,” “Longer,” and “Change tone.” In some examples, when the character count in the description field of the post composing area 904 falls below a designated threshold, only the “Suggest more” option is activated, while other options remain inaccessible.

In some examples, when the text entered by users exceeds the threshold, all functionalities within the editing panel 906 become available, as depicted in FIG. 9B. Selecting the “Change tone” option prompts the display of a tonal panel 908, which lists various tonal choices such as “Professional,” “Casual,” “Funny,” etc., as shown in FIG. 9C.

In some examples, when the cursor is placed at certain place in the post composing area 904, and upon selecting a tone, such as the “Casual” option, the system initiates the transformation of the post's content to reflect the chosen tone, integrating both existing text and images 902 to generate content that aligns with the selected style, as indicated in FIG. 9D.

The activation of the “Casual” tone temporarily disables the post composing area 904 and conceals both the tonal panel 908 and the keyboard. A loading status is displayed during this time to inform users of the ongoing content adaptation process, as shown in FIG. 9D.

An interactive element 910 is also introduced during the loading phase, allowing users the option to exit this mode. Engaging this element 910 stops the content generation, revealing the AI-generated content in the description field. If the generation process is not manually halted and successfully concludes, the post composing area 904 is reactivated, and the AI-assisted editing panel 906 becomes accessible again, as demonstrated in FIG. 9E. In some examples, the newly generated content automatically replaces the previous content, with the new additions being highlighted for review and further modification.

In some implementations, users have the capability to select a segment of the description within the post composing area 904 for tonal modification. As depicted in FIG. 9F, users can select a portion of the description when all options in the editing panel 906 are available.

Selecting the “Change tone” option triggers the display of tonal panel 908, which lists various tonal choices such as “Professional,” “Casual,” “Funny,” etc., as illustrated in FIG. 9G. Upon choosing a tone, like the “Casual” option, the system begins adapting the selected text to reflect the new tone. In some examples, the system may also incorporate elements from the associated images 902 to enhance the tonal conversion of the text.

Activating a specific tone, such as “Casual,” leads to the temporary deactivation of the post composing area 904 and the concealment of both the panel 908 and the keyboard. During this period, a loading status is shown, updating users on the progress of the content adaptation process, as shown in FIG. 9H.

Upon manual termination of the content generation by the user, or upon successful conclusion of the process, the post composing area 904 is reactivated, and access to the AI-assisted editing panel 906 is restored, as demonstrated in FIG. 9I. In some examples, the newly adapted content automatically replaces the originally selected text, with the fresh content highlighted for easy identification and potential further refinement.

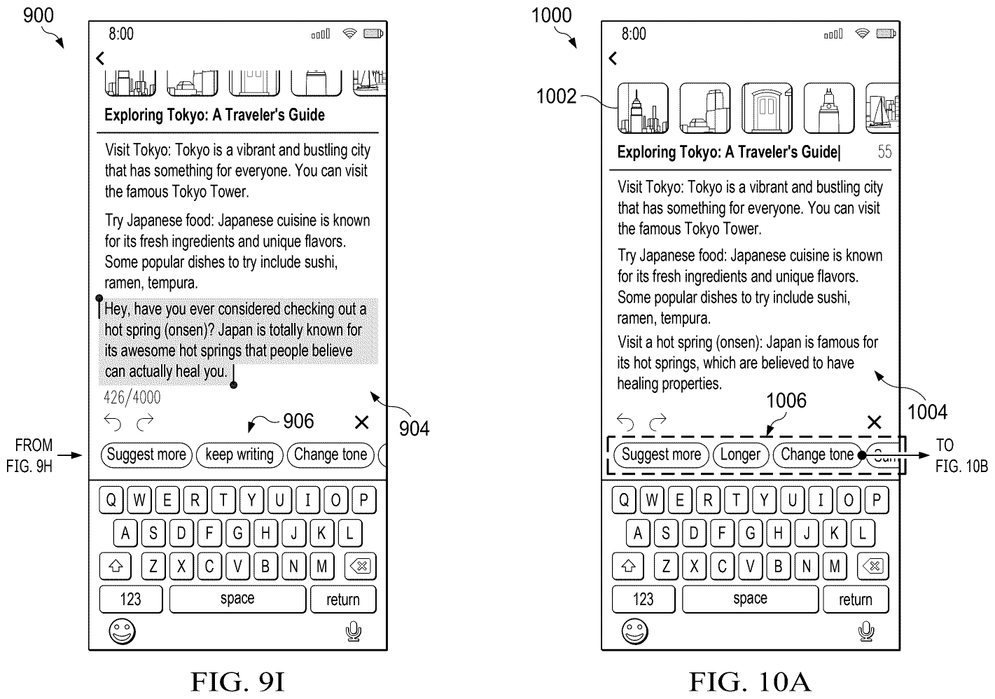

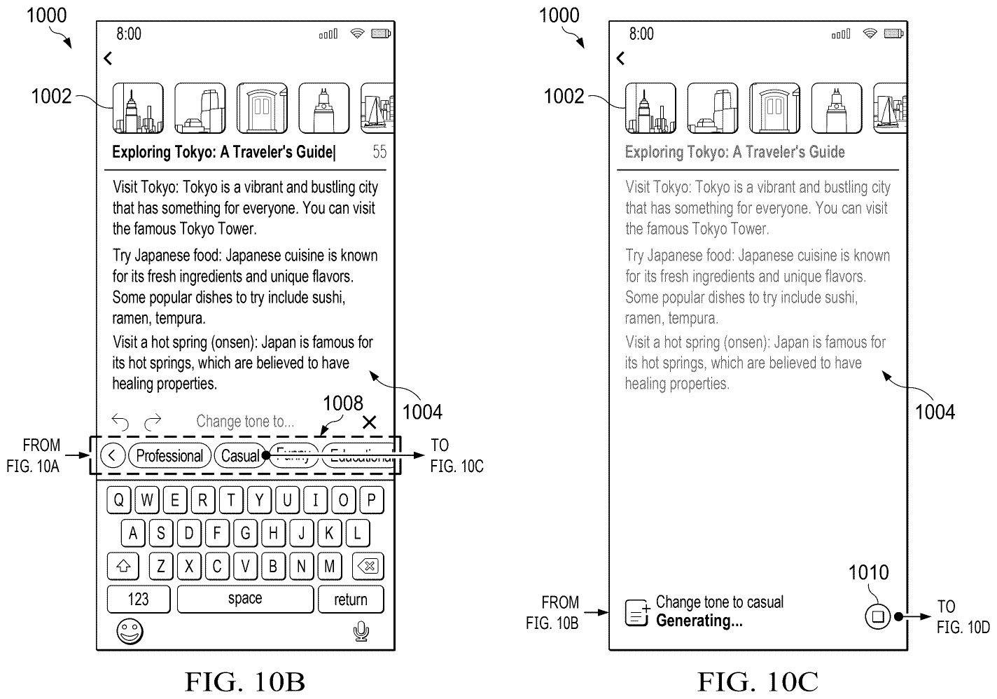

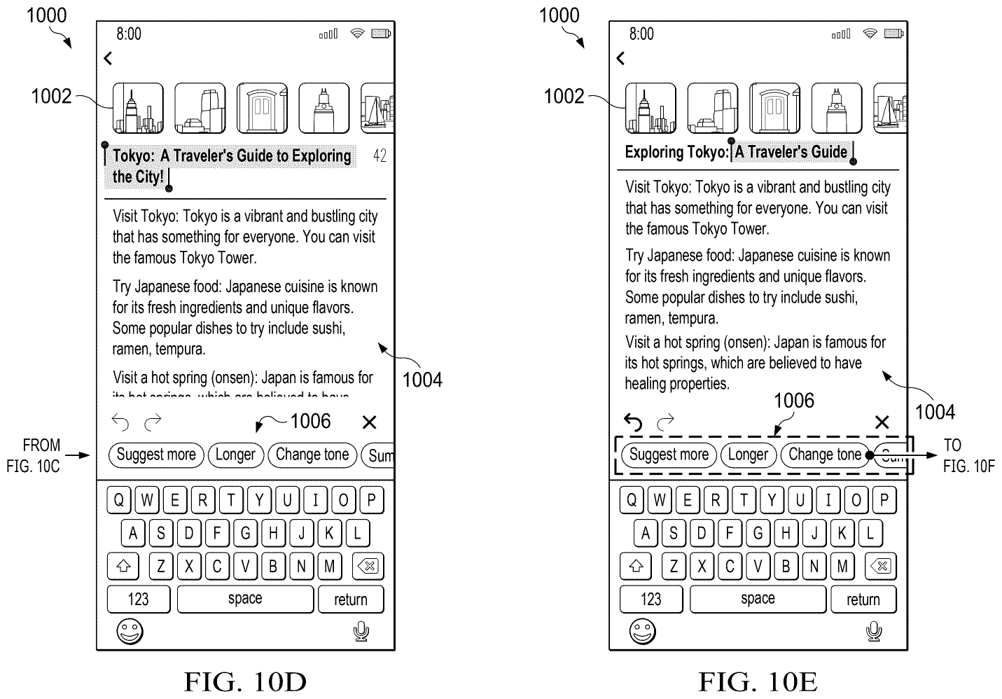

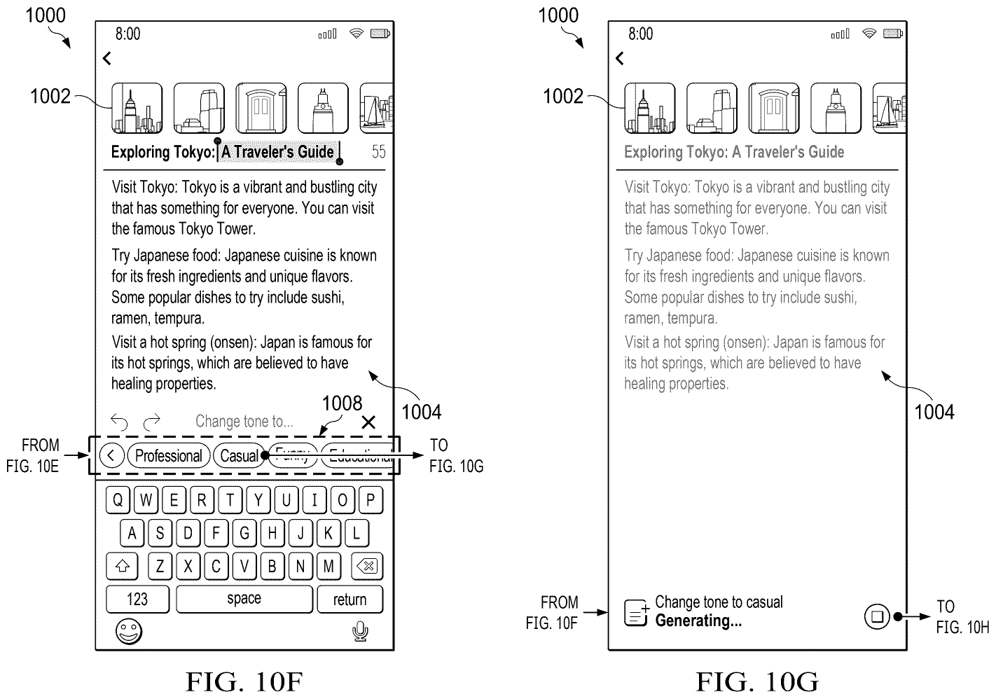

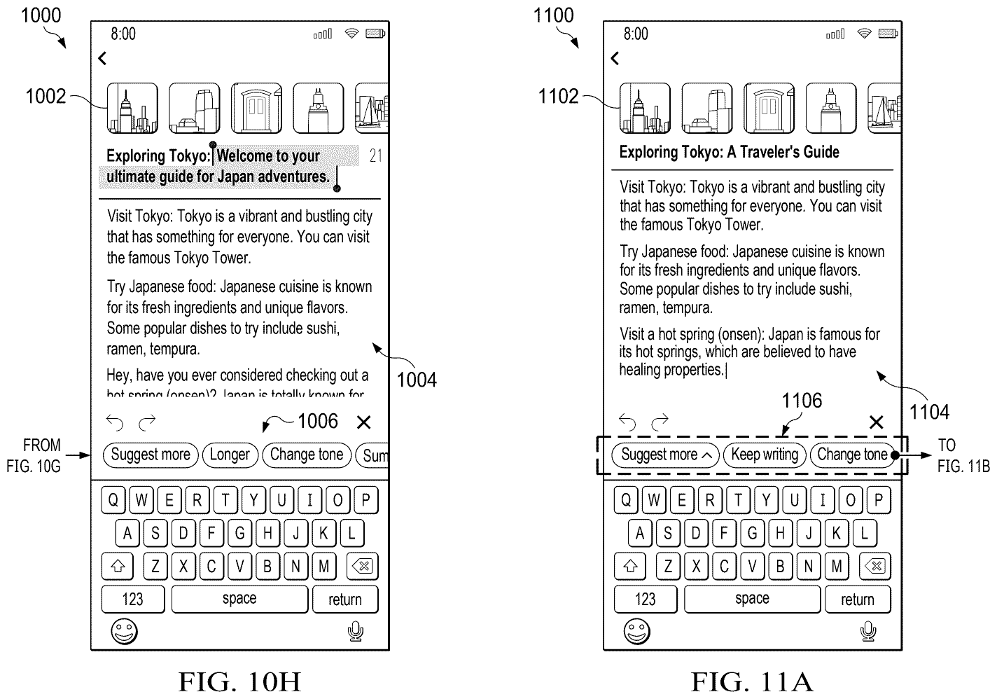

FIGS. 10A-10H illustrate an example UI 1000 for editing a post, according to one or more implementations of the disclosure.

FIG. 10A illustrates UI 1000 configured as a post editing page. The post editing page includes multiple images 1002, a post composing area 1004, and an AI-assisted editing panel 1006. The AI-assisted editing panel 1006 includes various editing options like “Suggest more,” “Longer,” and “Change tone.”

In some examples, when the text entered by users exceeds a threshold, all functionalities within the editing panel 1006 become available, as depicted in FIG. 10A. Selecting the “Change tone” option prompts the display of a tonal panel 1008, which lists various tonal choices such as “Professional,” “Casual,” “Funny,” etc., as shown in FIG. 10B.

In some examples, when the cursor is placed at a certain place in the title field in the post composing area 1004, and upon selecting a tone, such as the “Casual” option, the system initiates the transformation of the post's title to reflect the chosen tone, integrating both existing text and images 1002 to generate a title that aligns with the selected style, as indicated in FIG. 10C.

The activation of the “Casual” tone temporarily disables the post composing area 1004 and conceals both the tonal panel 1008 and the keyboard. A loading status is displayed during this time to inform users of the ongoing content adaptation process, as shown in FIG. 10C.

An interactive element 1010 is also introduced during the loading phase, allowing users the option to exit this mode. Engaging this element 1010 stops the content generation, revealing the AI-generated title in the title field. If the generation process is not manually halted and successfully concludes, the post composing area 1004 is reactivated, and the AI-assisted editing panel 1006 becomes accessible again, as demonstrated in FIG. 10D. In some examples, the newly generated title automatically replaces the previous title, with the new title being highlighted for review and further modification.

In some implementations, users have the capability to select a segment of the title within title field of the post composing area 1004 for tonal modification. As depicted in FIG. 10E, users can select a portion of the title when all options in the editing panel 1006 are available.

Selecting the “Change tone” option triggers the display of a tonal panel 1008, which lists various tonal choices such as “Professional,” “Casual,” “Funny,” etc., as illustrated in FIG. 10F. Upon choosing a tone, like the “Casual” option, the system begins adapting the selected portion of title to reflect the new tone. In some examples, the system may also incorporate elements from the associated images 1002 to enhance the tonal conversion of the text.

Activating a specific tone, such as “Casual,” leads to the temporary deactivation of the post composing area 1004 and the concealment of both the tonal panel 1008 and the keyboard. During this period, a loading status is shown, updating users on the progress of the content adaptation process, as shown in FIG. 10G.

Upon manual termination of the content generation by the user, or upon successful conclusion of the process, the post composing area 1004 is reactivated, and access to the AI-assisted editing panel 1006 is restored, as demonstrated in FIG. 10H. In some examples, the newly adapted content automatically replaces the originally selected text of the title, with the fresh content highlighted for easy identification and potential further refinement.

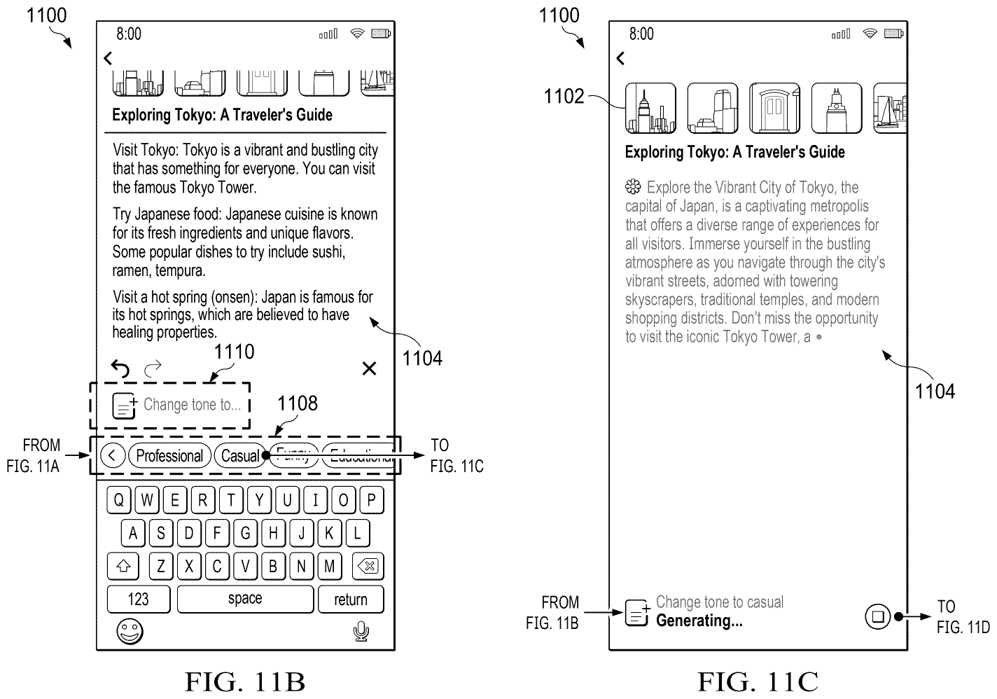

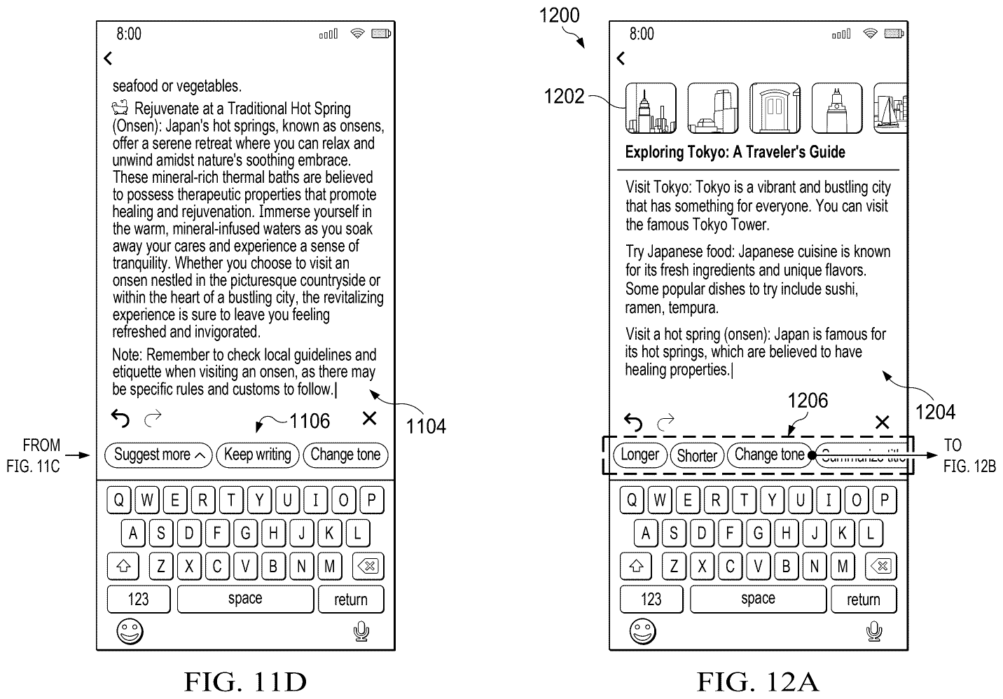

FIGS. 11A-11D illustrate an example UI 1100 for editing a post, according to one or more implementations of the disclosure.

FIG. 11A presents UI 1100 configured as a post editing page. The post editing page includes multiple images 1102, a post composing area 1104, and an AI-assisted editing panel 1106. The editing panel 1106 includes options such as “Suggest more,” “Keep writing,” and “Change tone.” In some examples, once the user has entered a number of characters exceeding a preset threshold, all options within the editing panel 1106 become available.

Selecting the “Change tone” option from the editing panel 1106 reveals a tonal panel 1108 that displays multiple tonal choices, including “Professional,” “Casual,” “Funny,” and “Educational,” as illustrated in FIG. 11B. Additionally, an element 1110 appears, signaling that the “Change tone” option is active.

When a user chooses a tonal option, such as “Casual” from panel 1108, the system initiates the adaptation of the post's content to the selected tone. Activating this particular tone results in the temporary deactivation of the post composing area 1104 and the concealment of the tonal panel 1108, the element 1110, and the keyboard. A loading status is also displayed during this phase, providing updates to the user about the ongoing content adaptation process, as shown in FIG. 11C.

If the user manually terminates the content generation or if the process concludes successfully, the post composing area 1104 is reactivated, and access to the AI-assisted editing panel 1106 is reinstated, as depicted in FIG. 11D. In some examples, the content that has been newly adapted automatically replaces the original text in the post composing area 1104.

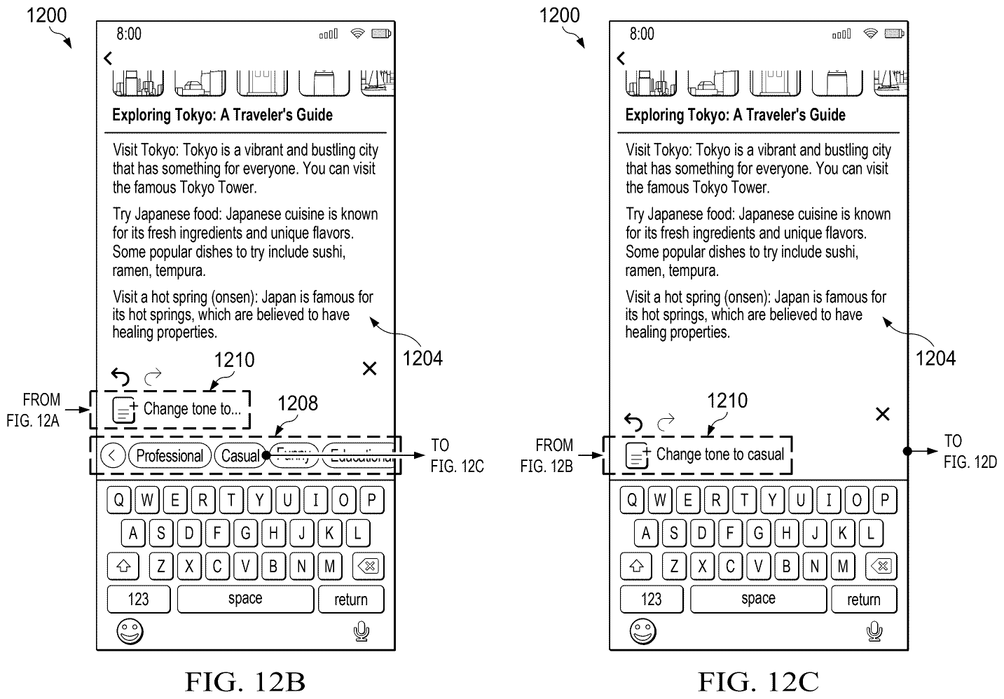

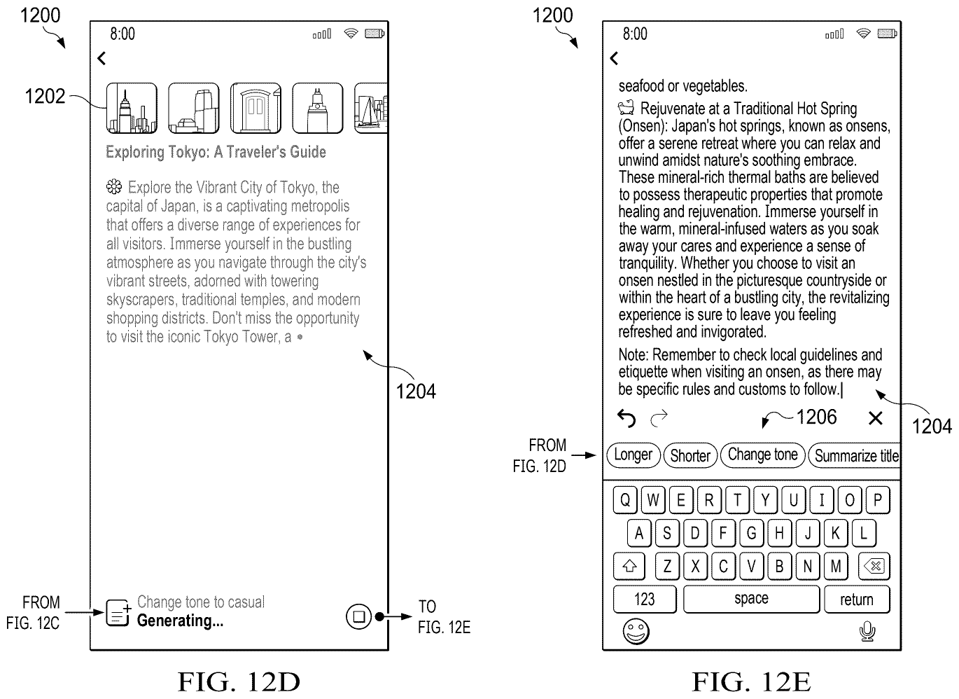

FIGS. 12A-12E illustrate an example UI 1200 for editing a post, according to one or more implementations of the disclosure.

FIG. 12A presents UI 1200 configured as a post editing page. The post editing page includes multiple images 1202, a post composing area 1204, and an AI-assisted editing panel 1206. The editing panel 1206 includes options such as “Longer,” “Shorter,” “Change tone,” and “Summarize title.” In some examples, once the user has entered a number of characters exceeding a preset threshold, all options within the editing panel 1206 become available.

Selecting the “Change tone” option from the editing panel 1206 reveals a tonal panel 1208 that displays multiple tonal choices, including “Professional,” “Casual,” “Funny,” and “Educational,” as illustrated in FIG. 12B. Additionally, an element 1210 appears, signaling that the “Change tone” option is active.

When a user selects a tonal option, such as “Casual” from panel 1208, the tonal panel 1208 vanishes, and the display element 1210 updates its text to indicate that the system is adapting the post content to the chosen tone, as illustrated in FIG. 12C. Following this selection, the system commences the adaptation process. Activating this tone leads to the temporary deactivation of the post composing area 1204 and the concealment of both the display element 1210 and the keyboard. Throughout this phase, a loading status is presented, which keeps the user informed about the progress of the content adaptation, as shown in FIG. 12D.

If the user manually stops the content generation or if the process completes successfully, the post composing area 1204 is reactivated, and access to the AI-assisted editing panel 1206 is restored, as depicted in FIG. 12E. In some examples, the newly adapted content automatically replaces the original text within the post composing area 1204.

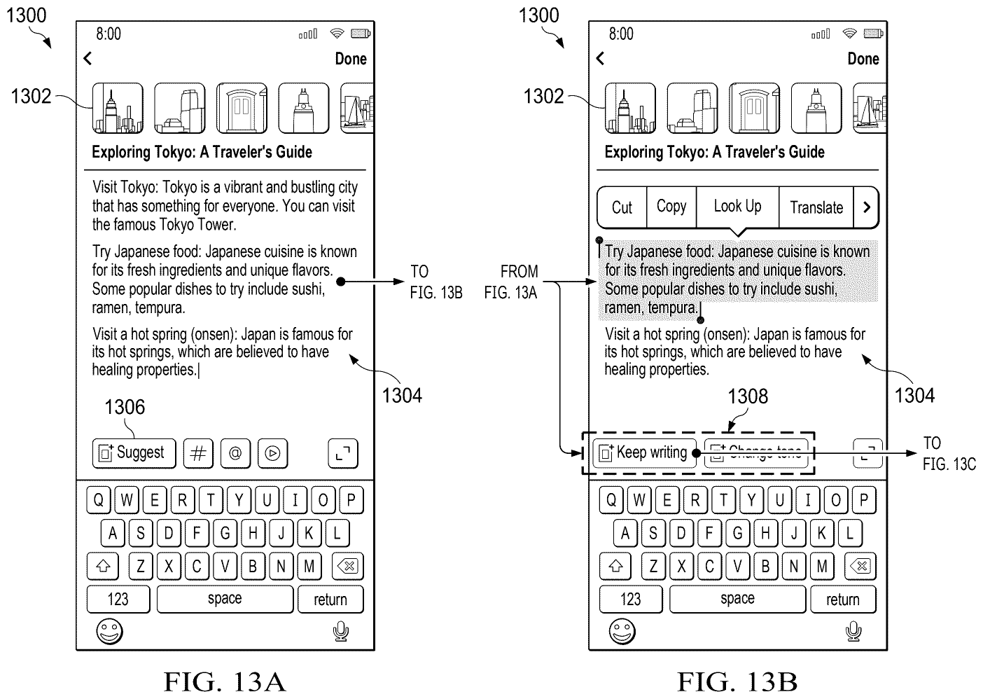

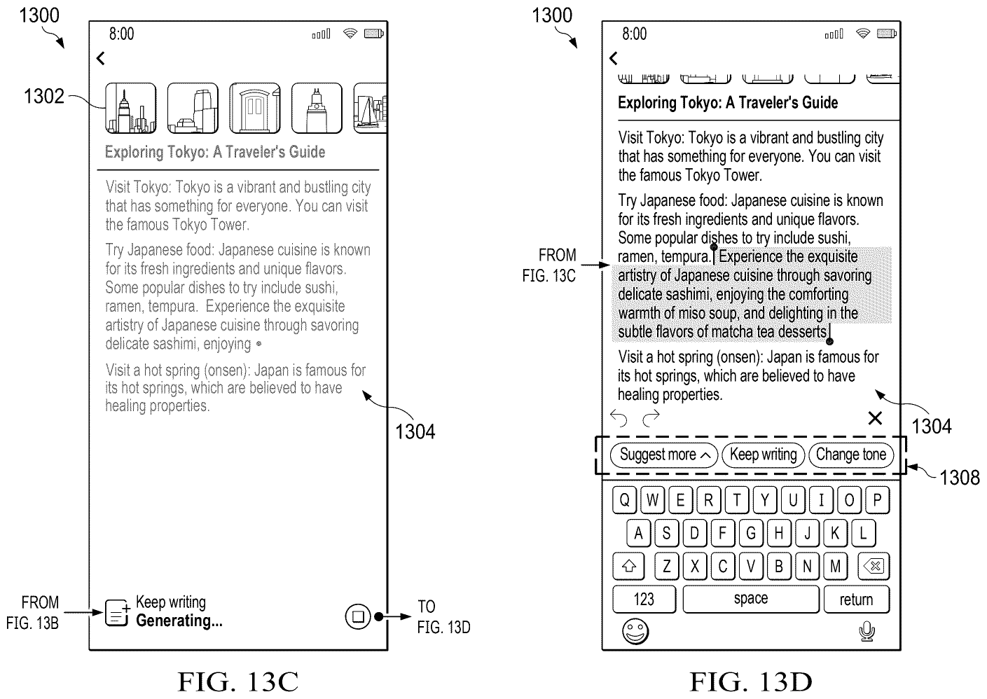

FIGS. 13A-13D illustrate an example UI 1300 for editing a post, according to one or more implementations of the disclosure.

FIG. 13A depicts UI 1300 configured as a post editing page. The post editing page includes multiple images 1302, a post composing area 1304, and an interactive element 1306 designed to activate AI-assisted editing features.

In some implementations, when users highlight a specific segment of the description within the post composing area 1304, a side menu, such as the editing panel 1308, becomes active, presenting AI-assisted editing options such as “Keep writing” and “Change tone,” as shown in FIG. 13B. In some examples, the editing panel 1308 can selectively display options that are appropriate for the highlighted text segment.

Selecting an editing option, such as the “Keep writing” option, prompts the system to continue generating content based on the highlighted text and associated images 1302.

The activation of an editing option results in the temporary deactivation of the post composing area 1304, and the concealment of both the editing panel 1308 and the keyboard. A loading status is also displayed during this phase, providing ongoing updates to the user about the progress of the content generation, as illustrated in FIG. 13C.

If the content generation is manually terminated by the user or concludes successfully, the post composing area 1304 is reactivated, and access to the AI-assisted editing panel 1308 is reinstated, as depicted in FIG. 13D.

In some examples, the newly generated content automatically replaces the originally selected text, with the new content being automatically selected and highlighted for easy review and further modifications. In some examples, the editing panel 1308 can show additional editing options, based on the newly selected portion of description.

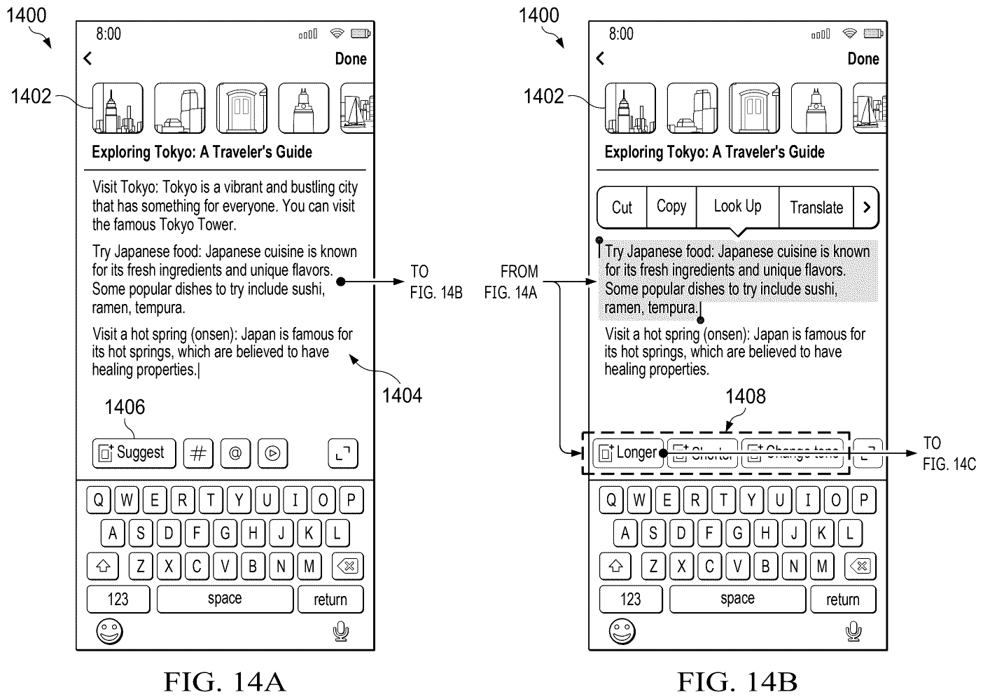

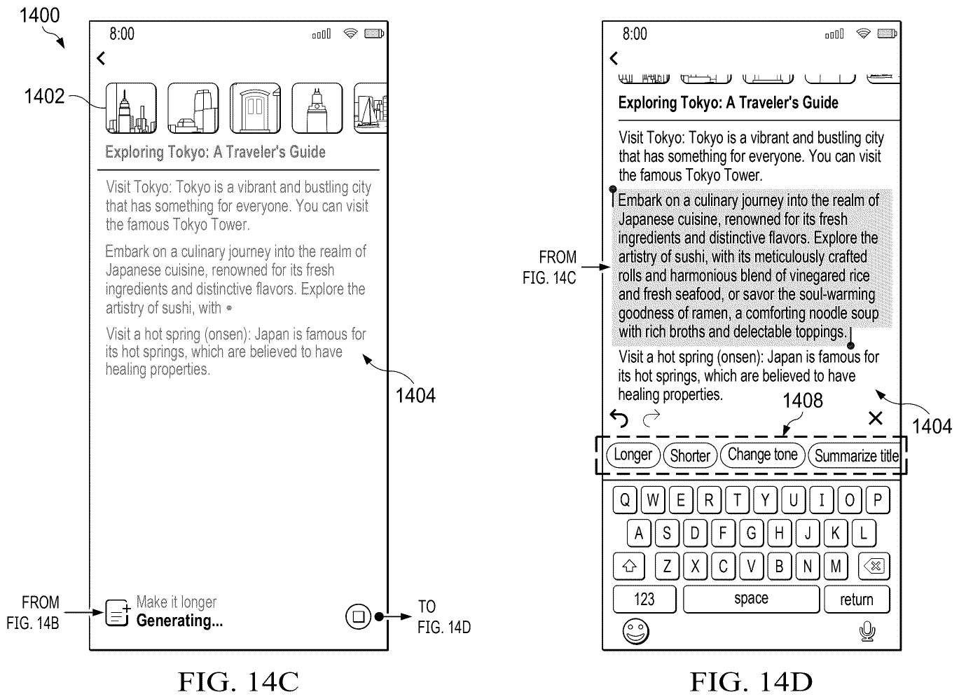

FIGS. 14A-14D illustrate an example UI 1400 for editing a post, according to one or more implementations of the disclosure.

FIG. 14A depicts UI 1400 configured as a post editing page. The post editing page includes multiple images 1402, a post composing area 1404, and an interactive element 1406 designed to activate AI-assisted editing features.

In some implementations, when users highlight a specific segment of the description within the post composing area 1404, a side menu, such as the editing panel 1408, becomes active, presenting AI-assisted editing options such as “Longer,” “Shorter,” and “Change tone,” as shown in FIG. 14B. In some examples, the editing panel 1408 can selectively display options that are appropriate for the highlighted text segment.

Selecting an editing option, such as the “Longer” option, prompts the system to continue generating content based on the highlighted text and associated images 1402.

The activation of an editing option results in the temporary deactivation of the post composing area 1404, and the concealment of both the editing panel 1408 and the keyboard. A loading status is also displayed during this phase, providing ongoing updates to the user about the progress of the content generation, as illustrated in FIG. 14C.

If the content generation is manually terminated by the user or concludes successfully, the post composing area 1404 is reactivated, and access to the AI-assisted editing panel 1408 is reinstated, as depicted in FIG. 13D.

In some examples, the newly generated content automatically replaces the originally selected text, with the new content being automatically selected and highlighted for easy review and further modifications. In some examples, the editing panel 1408 can show additional editing options, e.g., “Summarize title,” based on the newly selected portion of description.

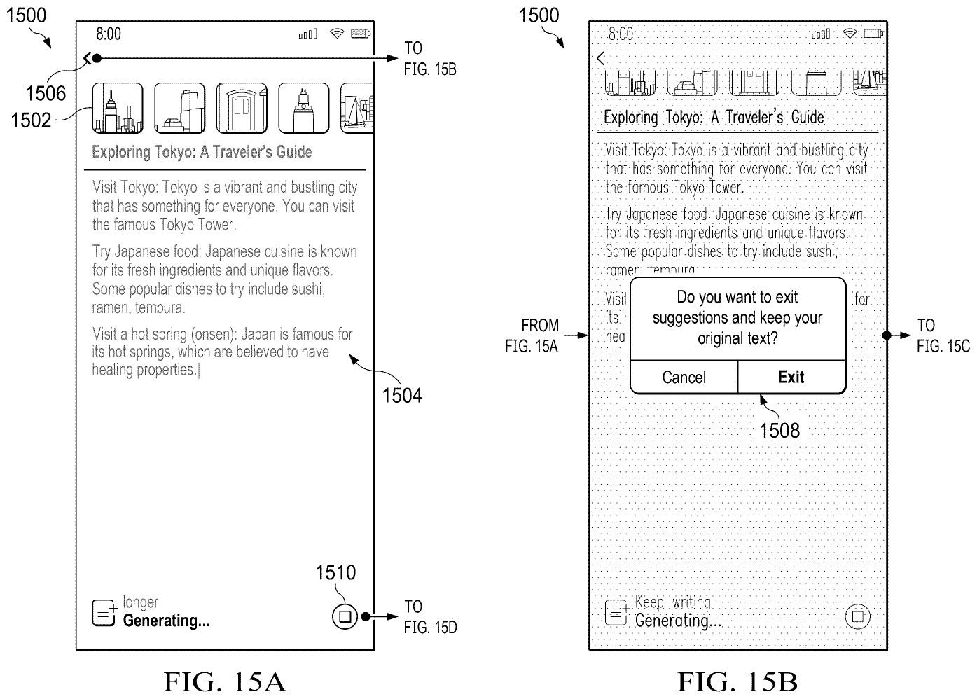

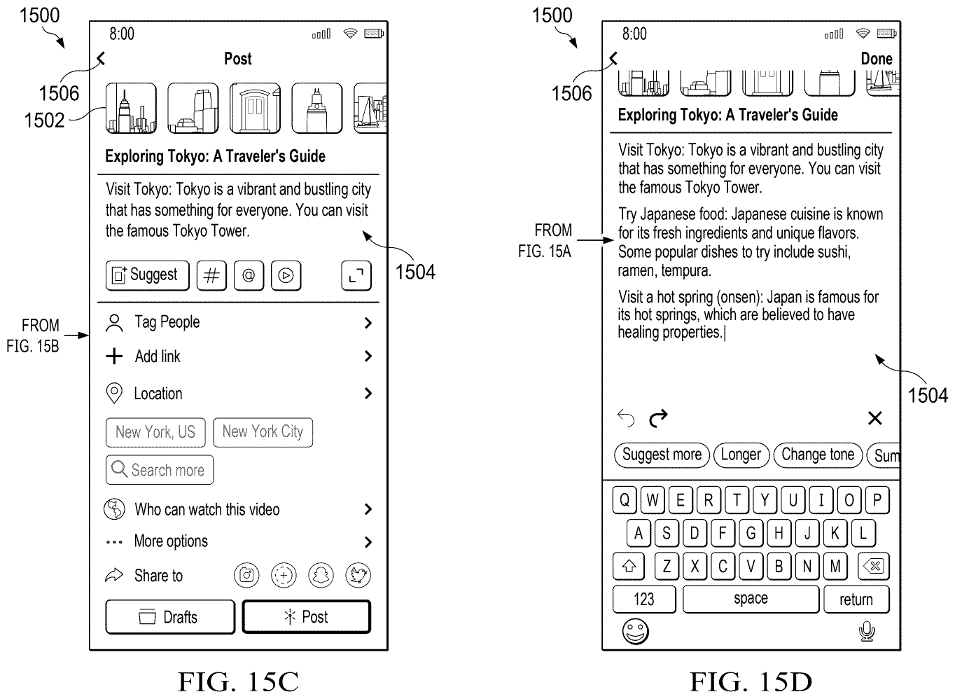

FIGS. 15A-15D illustrate an example UI 1500 for editing a post, according to one or more implementations of the disclosure.

FIG. 15A illustrates UI 1500, configured as a post editing page, which includes images 1502 and a post composing area 1504. In some implementations, when AI-assisted editing features are activated and a specific editing option is selected by the user, the system initiates content generation based on that option. During this generation process, both the images 1502 and the post composing area 1504 become inaccessible to the user, ensuring uninterrupted content creation.

In some implementations, UI 1500 includes interactive elements that provide users with the capability to interrupt the generation process. As depicted in FIG. 15A, the post editing page includes an interactive element 1506 that allows users to revert to a previous stage or page. If a user activates element 1506 during content generation, an alert 1508 is displayed, inquiring whether the user wishes to terminate the generation process and retain the original text. Users have the option to either continue with the generation process or confirm its termination, as illustrated in FIG. 15B.

If the user decides to continue with the termination, the newly generated content is discarded, and the post editing page reverts to displaying the previous content, as shown in FIG. 15C. Additionally, upon exiting the generation process, some other interactive elements may become visible, offering functionalities such as adding hashtags, ‘@’ mentions, tagging, hyperlink insertion, and location services.

Furthermore, UI 1500 includes an element 1510 that allows users to directly halt the content generation process. Activating this element 1510 immediately stops the generation, retains the original content, and discards any newly generated content, as shown in FIG. 15D. Upon halting the generation process, access to both the images 1502 and the post composing area 1504 is restored, enabling the user to continue editing or modifying the original content.

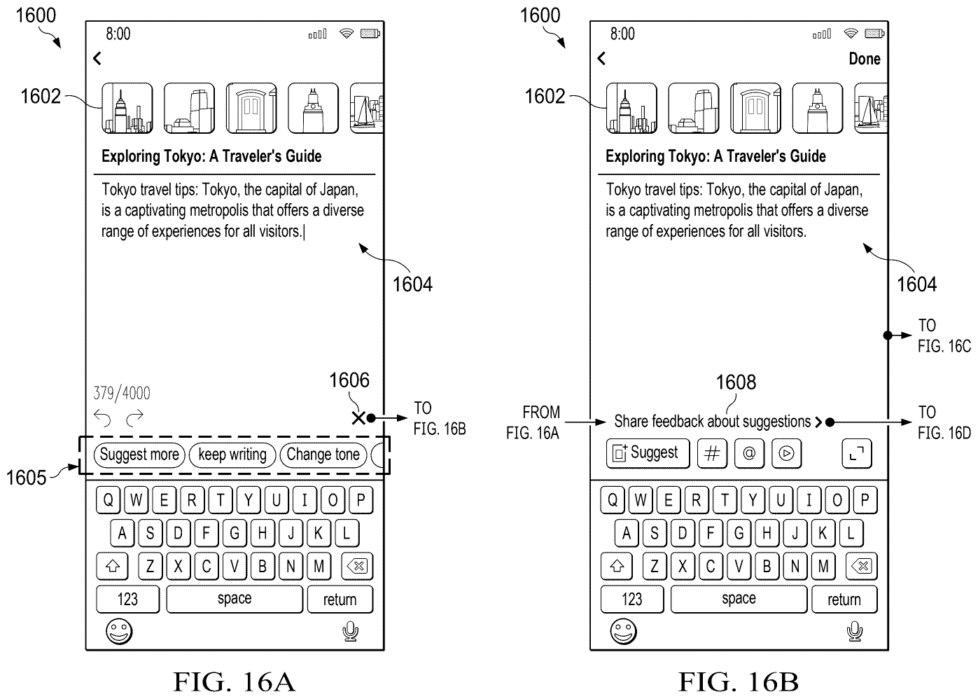

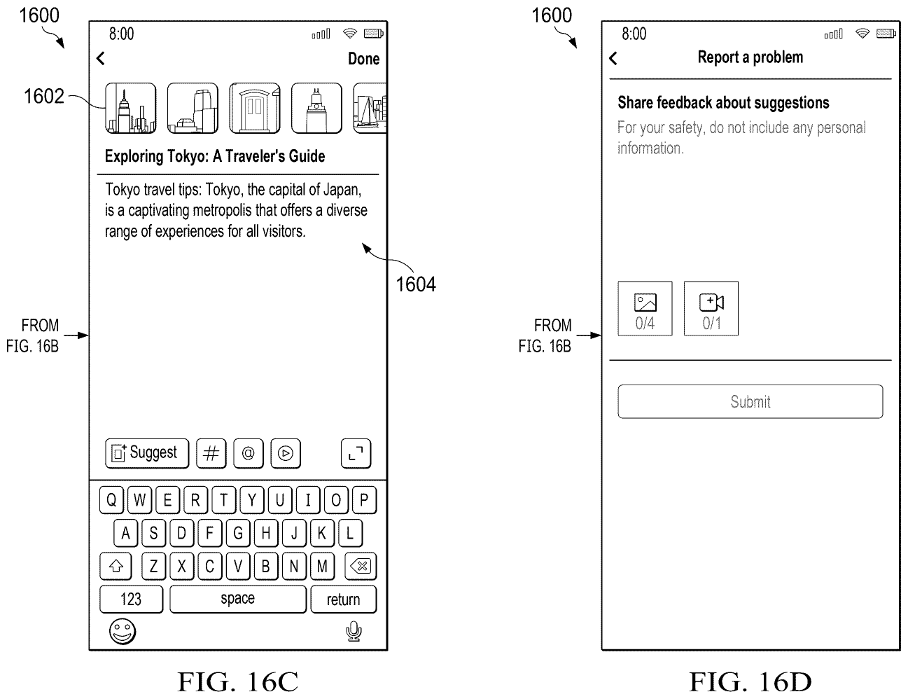

FIGS. 16A-16D illustrate an example UI 1600 for editing a post, according to one or more implementations of the disclosure.

FIG. 16A illustrates UI 1600, configured as a post editing page, which includes images 1602, a post composing area 1604, an AI-assisted editing panel 1605, and an interactive element 1606 designated for exiting AI-assisted editing functionalities.

When users activate element 1606 to disengage from the AI-assisted editing features, another interactive element 1608 (e.g., as a banner) appears, signaling to users the opportunity to provide feedback, as demonstrated in FIG. 16B. In some implementations, the interactive element 1608 for prompting user feedback can be configured to appear every time, once a number of times that the AI-assisted editing features is used, once during a period of time, or randomly. In some implementations, the interactive element 1608 for prompting user feedback can be configured to be displayed in a nondisruptive or nonintrusive manner, for example, by using simple symbols (e.g., “>”), occupying small or minimal space in the UI, in a location (e.g., outside the post composing area 1604 and the keyboard) that does not interrupt with the user's main interaction with the post (e.g., editing the context of the post), and/or disappearing automatically without any user interaction with the interactive element 1608. For example, if a user engages with other elements on the UI 1600 (that is, the user does not interact with the interactive element 1608) for a duration exceeding a predefined threshold, element 1608 will automatically be dismissed, without any further user interaction, as depicted in FIG. 16C. In this way, unlike intrusive methods like pop-ups or redirecting to another page, the interactive element 1608 for prompting user feedback is implemented to improve user experience without disrupting the user's workflow.

Activating the interactive element 1608 transitions UI 1600 to a feedback page, where users are invited to submit their feedback, as shown in FIG. 16D. In some implementations, the feedback is collected and used to refine or train the GenAI models to improve on the AI-assisted content generation. This transition facilitates a seamless feedback collection process, enhancing the user's interaction with the system and providing valuable insights for future improvements.

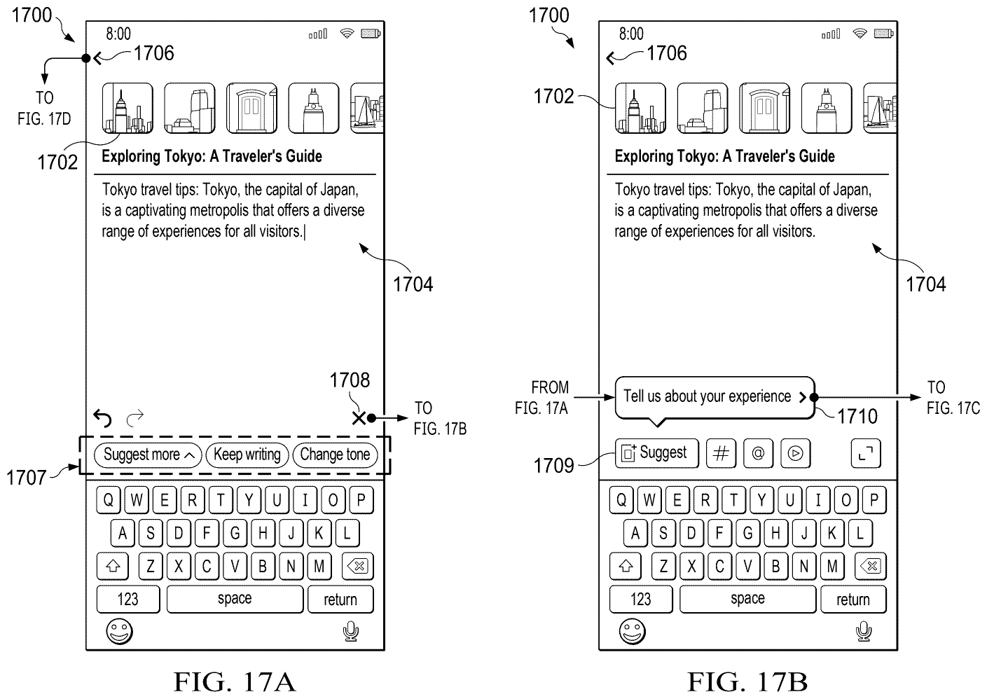

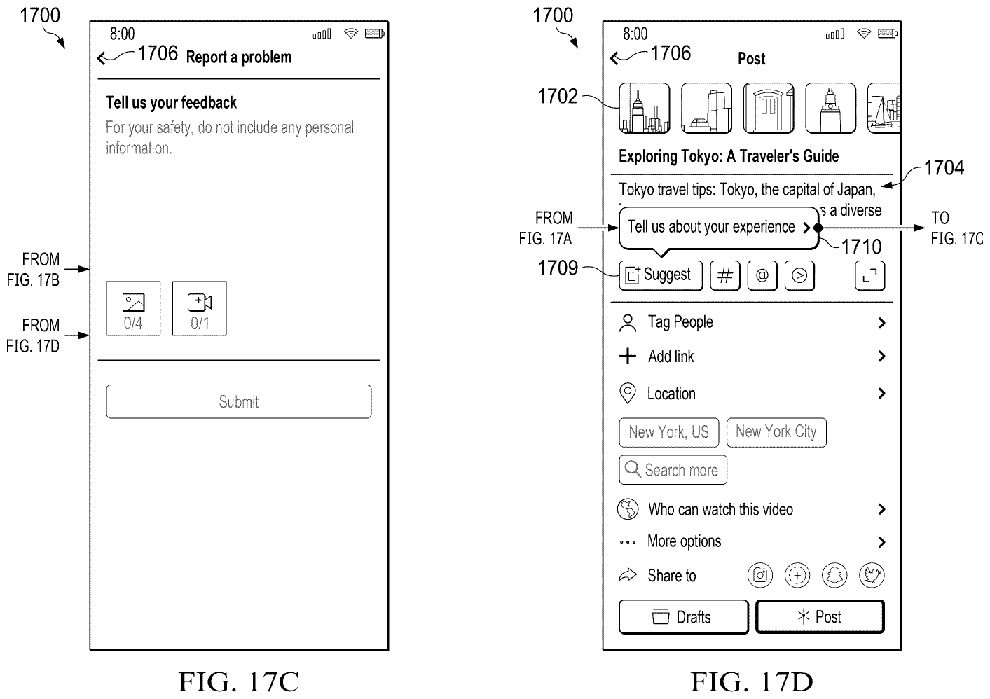

FIGS. 17A-17D illustrate an example UI 1700 for editing a post, according to one or more implementations of the disclosure.

FIG. 17A presents UI 1700, configured as a post editing page that includes images 1702, a post composing area 1704, an interactive element 1706 for reverting to a previous stage or page, an AI-assisted editing panel 1707, and an element 1708 to exit AI-assisted editing features.

In some implementations, when users interact with element 1708 to exit the editing features, the editing panel 1707 vanishes. Simultaneously, an element 1709 for reactivating the AI-assisted editing features is displayed alongside an element 1710 that prompts users to provide feedback, as depicted in FIG. 17B.

Activating element 1710 prompts UI 1700 to transition to a feedback page, facilitating the collection of user feedback on their editing experience, as illustrated in FIG. 17C.

In some implementations, when users engage element 1706 to return to a prior stage or page, the editing panel 1707 vanishes, and both elements 1709 and 1710 become visible at that stage or page, as shown in FIG. 17D. Selecting element 1710 in FIG. 17D also directs users to the feedback page depicted in FIG. 17C, thus maintaining a consistent method for gathering user insights across different stages of the editing process.

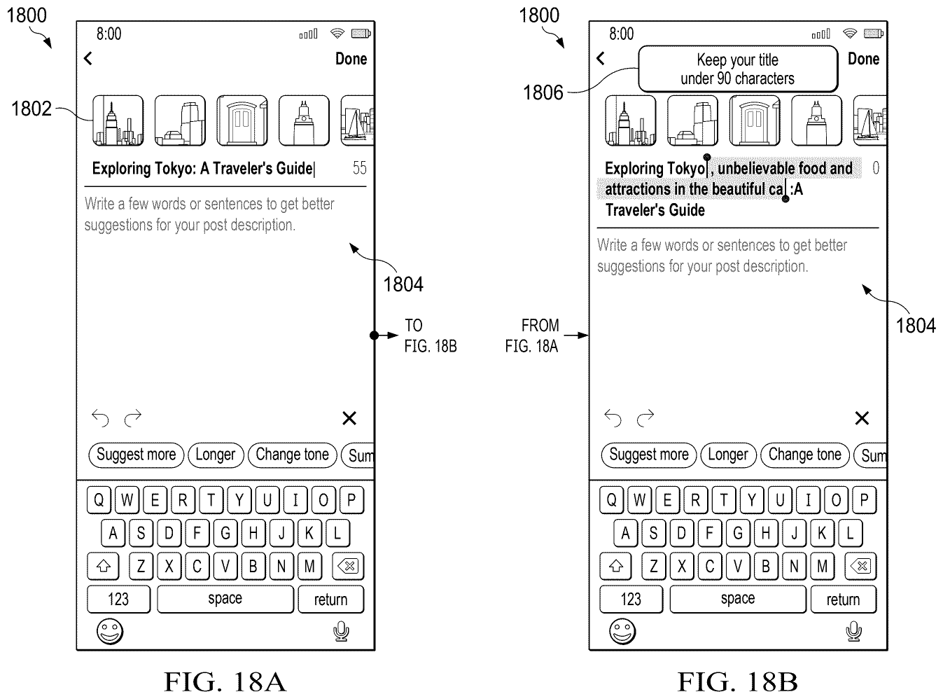

FIGS. 18A-18B illustrate an example UI 1800 for editing a post, according to one or more implementations of the disclosure.

FIG. 18A displays UI 1800 configured as a post editing page that includes images 1802 and a post composing area 1804. In some implementations, if the title field within the post composing area 1804 already contains text, users have the option to activate an AI-assisted editing feature to generate new title content and insert the new content in the middle of the title content. In scenarios where the character count in the title field, including the newly generated content, exceeds a predetermined threshold, only a portion of this new content will be retained in the title field to keep the character count within the limit. Concurrently, a notification 1806 will be provided, informing users that the inclusion of the new content has resulted in the title's character count exceeding the allowable limit.

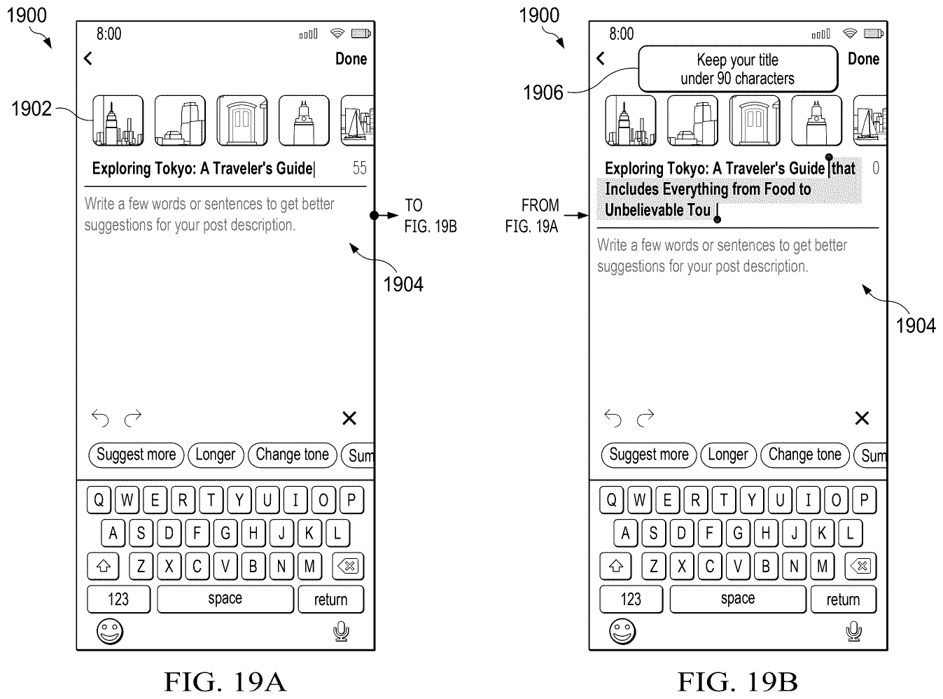

FIGS. 19A-19B illustrate an example UI 1900 for editing a post, according to one or more implementations of the disclosure.

FIG. 19A displays UI 1900 configured as a post editing page that includes images 1902 and a post composing area 1904. In some implementations, if the title field within the post composing area 1904 already contains text, users have the option to activate an AI-assisted editing feature to generate new title content and insert the new content at the end of the title content. In scenarios where the character count in the title field, including the newly generated content, exceeds a predetermined threshold, only a portion of this new content will be retained in the title field to keep the character count within the limit. Concurrently, a notification 1906 will be provided, informing users that the inclusion of the new content has resulted in the title's character count exceeding the allowable limit.

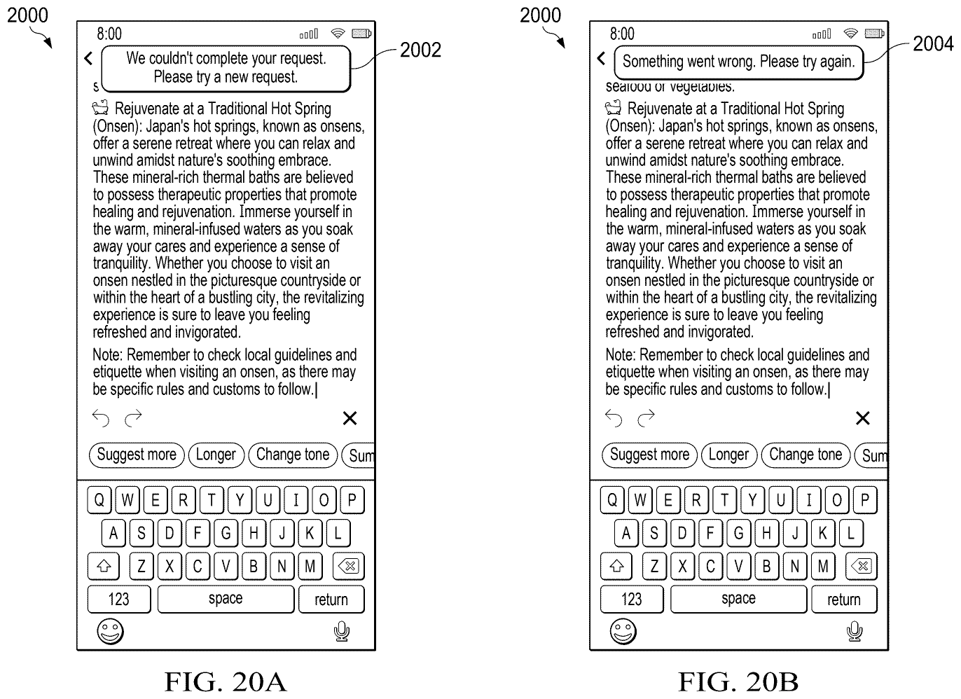

FIGS. 20A-20B illustrate an example UI 2000 for editing a post, according to one or more implementations of the disclosure.

In some implementations, the system may experience operational difficulties, resulting in a failure to produce results in response to a user's activation of an AI-assisted editing feature, or user input may be restricted due to specific requirements. Under these circumstances, a notification (examples of which include notifications 2002 and 2004 depicted in FIGS. 20A and 20B) may be issued to inform users that their requests could not be processed. The notification advises users that they may either attempt the request again later or submit a new request, thereby keeping users informed and providing guidance on next steps.

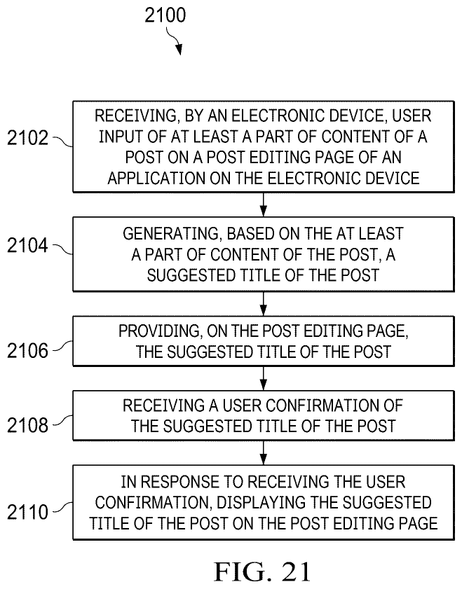

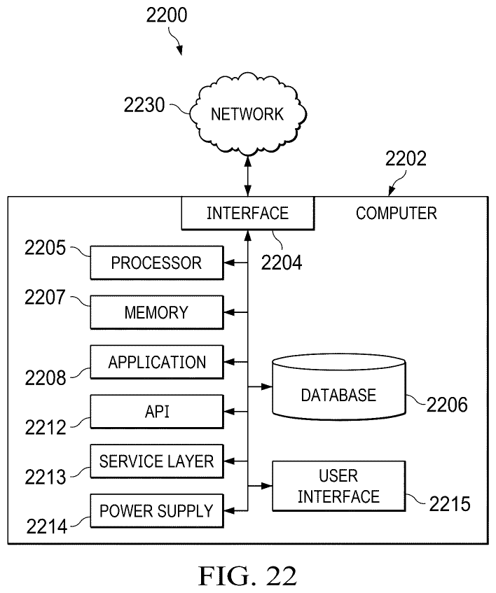

FIG. 21 illustrates a block diagram of an example process 2100 of editing a post, according to one or more implementations of the disclosure. Process 2100 will be described with reference to elements as illustrated in one or more of FIGS. 1-20. It should be noted that while the elements in one or more of FIGS. 1-20 are described herein as examples, these are not meant to be limiting, process 2100 can be performed with respect to any suitable elements. The operations shown in process 2100 may not be exhaustive and that other operations can be performed as well before, after, or in between any of the illustrated operations. Further, some of the operations may be performed simultaneously, or in a different order than shown in FIG. 21.

An electronic device receives user input (e.g., images 202) of at least a part of content of a post on a post editing page (e.g., UI 200 of FIG. 2A) of an application on the electronic device (2102). In some examples, the user input can include textual descriptions, photographic images, or video clips that a user selects or captures to compile a social media post, blog entry, or news article directly within the application. For example, a user might type a detailed account of their recent vacation, add a selection of photos from the trip, and possibly include a video clip of a scenic view. This input can be then processed on the post editing page, where the user can also access tools for formatting the text, editing the images, or trimming the video, to enhance the presentation of the final post before it is published or shared through the application.

A suggested title (e.g., the suggested title of FIG. 6D) of the post is generated based on the at least a part of content of the post (2104). In some implementations, the electronic device generates, based on the at least the part of content of the post, the suggested title of the post using one or more pre-trained GenAI models. For example, the at least the part of content of the post is sent to one or more pre-trained generative artificial intelligence (GenAI) models, and the suggested title of the post is outputted by the one or more pre-trained GenAI models. In some examples, the one or more GenAI models are capable of generating new content, such as text, images, music, or other media, based on learned patterns and data. The GenAI models can use algorithms to analyze and process large datasets, identifying underlying structures and features that define the input data. The GenAI models can then utilizes this understanding to generate new, similar instances of data that retain the characteristics of the original dataset.

In some implementations, the one or more pre-trained GenAI models are executed in a remote server. In some examples, user input on the electronic device can be prepared for secure transmission via encryption and serialized into a suitable format. The input data can be compressed to optimize transmission speed and reduce bandwidth usage. The processed data then can be sent over the internet using secure transfer protocols to a remote server equipped with generative AI (GenAI) models. Upon receipt, the server can process the data, which may involve decoding and tokenization, to ready it for the GenAI models. These models then analyze and generate new content based on the input. The generated content is subsequently post-processed into a user-friendly format, packaged into a response, and securely transmitted back to the user's device using similar secure protocols. The user device receives and verifies the integrity of the data before rendering the generated content for user interaction, completing a secure and efficient cycle of content generation and delivery.

In some implementations, the one or more pre-trained GenAI models are implemented locally on the electronic device. This local implementation can allow for real-time data processing and generation without the latency associated with data transmission over the internet. For example, the user inputs content into the device, which is then processed by the on-device GenAI models. These models analyze the input, generate new content, and immediately display this content on the user device. Or in some other implementations, some of one or more pre-trained GenAI are implemented locally on the electronic device while some of one or more pre-trained GenAI are implemented on a remote server, and the suggested title of the post is generated using the one or more pre-trained GenAI models in a hybrid mode.

In some implementations, the at least a part of content of a post comprises at least one of graphical content items or textual content items, and the suggested title of the post is generated based on the at least a part of content of the post.

In some implementations, the at least a part of content of a post includes one or more graphical content items. In such implementations, the electronic device receives the one or more graphical content items at the post editing page of the application on the electronic device. A textual description of the one or more graphical content items is generated based on the one or more graphical content items using a first model. The suggested title of the post is generated based on the textual description of the graphical content items using a second model. In some implementations, the first model can be a model that can convert or otherwise transform the one or more graphical content items to obtain the textual description of the one or more graphical content items. For example, the first model can be a transcription model that obtain text from a photo or video content items. In some examples, the first and second model are GenAI models.

In some examples, the one or more GenAI models can employ computer vision techniques to analyze graphical content, detecting objects, recognizing patterns, and understanding the scene composition of graphical input, such as images, videos, or designs, of a post. Techniques such as object detection, segmentation, and feature extraction can be utilized to deconstruct graphical content into comprehensible elements. Once the visual elements are identified, the GenAI models can employ a pre-trained language generation module to transform these visual insights into coherent textual descriptions. In some examples, this transforming process involves synthesizing the recognized elements, their relationships, and contextual cues to produce accurate and relevant descriptions, with natural language processing (NLP) techniques ensuring grammatical correctness and logical structure. Following the creation of a detailed textual description, another AI-driven linguistic model can extract key themes and details from the text to generate a title. By analyzing the semantic content, the model can generate a concise and informative title that encapsulates the main message or the most striking elements of the textual content, thus ensuring the title is both engaging and descriptive.

In some implementations, prompt engineering techniques are employed to design and refine the inputs (prompts) provided to AI models to elicit optimal or preferred outputs. The prompt engineering can be pertinent in the context of large language models and other generative models, where it serves to enhance the quality and specificity of the inputs. Such improvements can impact the accuracy, relevance, and practicality of the outputs generated by these models.

In some implementations, a collection of prompts can be systematically crafted to activate the generative function of an AI model. In some examples, depending on the particular requirements of a use case, this collection of prompts can be curated, augmented, or modified in response to user interactions, such as textual inputs and selections made on interface element 116. Subsequently, these tailored prompts are fed into the generative AI model.

In some examples, prompts can be configured to reduce potential misinterpretations by the AI system. In some examples, prompts can incorporate essential context to direct the AI towards producing relevant responses. Prompts can be tailored to correspond with specified outcomes or tasks, which may include generating textual content, code, images, or making predictive assessments. Furthermore, prompts can be optimized to achieve targeted outputs with reduced input, thereby enhancing efficiency in terms of computational resources and processing time.

Furthermore, an application, along with its corresponding server infrastructure, can be configured to generate, append, eliminate, modify, or otherwise manage a repository of these prompts. This dynamic adjustment of the prompt library can be driven by user feedback, facilitating the continuous refinement of the prompts to enhance performance and relevance.

In some implementations, the at least a part of content of a post includes one or more graphical content items and one or more textual content items. In such implementations, the electronic device receives the one or more graphical content items and the one or more textual content items at the post editing page of the application on the electronic device. A textual description of the one or more graphical content items is generated based on the one or more graphical content items using a third model. The suggested title of the post is generated based on the one or more textual content items and the textual description of the one or more graphical content items using a fourth model. In some examples, the third and fourth models are GenAI models. In some examples, user input can include both graphical and textual content. In such examples, one model can be used to generate a textual description of the graphical input. Subsequently, another model can utilize both the newly generated textual description and any additional textual input provided by the user to create a title for the post.

In some implementations, the at least a part of content of a post includes one or more textual content items. In such implementations, the suggested title of the post is generated based on the at the one or more textual content items.

In some implementations, a plurality of titles of the post are generated based on the at least a part of content of the post. In such implementations, a suggestion of the plurality of titles of the post (e.g., the content versions 210 of FIG. 2B) is provided on the post editing page.

The suggested title of the post is provided on the post editing page (2106). In some examples, the generated title(s) can be transmitted from the backend system, either on the local device or a remote server, to the electronic device. In some examples, to display a suggested title on a user device, a distinct section of the user interface on the electronic device, such as a dialog box or overlay, can be designed to use a unique style to differentiate the suggestion.

A user confirmation of the suggested title of the post is received (2108). For example, user can tap a “Select” button associated with one of the suggested titles to confirm selection of the title.

In response to receiving the user confirmation, the suggested title of the post is displayed on the post editing page (2110). For example, the user-approved title can populate a title field (e.g., title field 212 of FIG. 2C) of the post upon user's confirmation.

In some implementations, a user instruction (e.g., user taps the “Longer” option in editing panel 506 of FIG. 5B) is received to continue drafting the post. In response to receiving the user instruction, additional textual content is generated based on existing content of the post, and the additional textual content is inserted in the post.

In some implementations, a first user selection (e.g., the selected portion of text in FIG. 13B) of a portion of textual content of the post is received as a selected portion of textual content. In response to the first user selection, one or more editing options (e.g., the editing options in editing panel 1308 of FIG. 13B) are displayed on the post editing page. A second user selection of one of the one or more editing options is received as a selected editing option. In response to the second user selection, an editing operation corresponding to the selected editing option is performed on the selection portion of textual content.

In some implementations, one or more interactive elements (e.g., elements 509 of FIG. 5D) for switching between multiple versions of user-confirmed post content, such as titles and/or descriptions previously populated in a post composing area for a post, are provided on the post editing page. In response to a user interaction with one of the one or more interactive elements, current content of the post is replaced with one of the multiple versions of user-confirmed post content. In some implementations, the recent M (e.g., 20) versions of user-confirmed post content are stored. In some implementations, the version control elements 509 can include one element (e.g., a “<” or undo symbol) to resume to the last version, discard changes happen after the last version. In some implementations, the version control elements 509 can include one element (e.g., a “>” or redo symbol) to resume to the current version, discard changes happen between the last version and the current version. In some implementations, users make changes, but no AI-assisted content is generated, the version control may not store those versions that does not include the AI-assisted content and the version control elements 509 cannot undo/redo only based on the user input.

In some implementations, a user instruction (e.g., user taps the “Change tone” option in the editing panel 906 of FIG. 9B) to change a tone of textual content of the post is received. In response to the user instruction, one or more tone options (e.g., the tonal options in tonal panel 908 of FIG. 9C) are provided on the post editing page. A user selection of one of the one or more tone options is received as a selected tone option. New textual content of the post that corresponds to the selected tone option is generated.

In some implementations, a first interactive element (e.g., element 1606 of FIG. 16A) to exit an AI-assisted editing mode is displayed on the post editing page. A first user interaction with the first interactive element is received. In response to the first interactive elements, a second interactive element (e.g., element 1608 of FIG. 16B) for providing user feedback is provided on the post editing page. A second user interaction with the second interactive element is received. A feedback page (e.g., the feedback page of FIG. 16D) is provided in response to the second user interaction.

FIG. 22 illustrates a block diagram of an example computer system 2200 used to provide computational functionalities associated with described algorithms, methods, functions, processes, flows, and procedures, as described in the disclosure, according to one or more implementations. The example computer system 2200 can include an electronic device 2202 and a network 2230. The computer system 2200 can include additional or different components, such as, one or more remote servers that are communicatively linked with the electronic device 2202.

The electronic device 2002 can include a digital TV, a desktop computer, a work station, a smart appliance, or another stationary terminal. In some implementations, the electronic device 2202 is a portable device, such as, a notebook computer, a digital broadcast receiver, a handheld device, a portable multimedia player (PMP), an in-vehicle terminal, an Internet of Things (IoT) device. For example, the electronic device 2202 can be a phone, a smartphone, a pad (tablet computer), a digital assistant device (e.g., a PDA (personal digital assistant)), or another handheld device.

In some aspects, the electronic device 2202 may include a computer that includes a user interface 2215. The user interface 2215 can include an input device, such as a keypad, keyboard, touch screen/touch display, camera, microphone, accelerometer, gyroscope, AR/VR sensors, or other device that can accept user information, and an output device that conveys information associated with the operation of the electronic device 2202, including digital data, visual, or audio information (or a combination of information), or a graphical user interface (GUI). In some implementations, the user interacts with the GUI, for example, through contacts and/or gestures on or in front of the touch screen, for example, to implement the functions such as digital photographing/videoing, instant messaging, social network interacting, image/video editing, drawing, presenting, word/text processing, website creating, game playing, telephoning, video conferencing, e-mailing, web browsing, digital music/digital video playing, etc.

The electronic device 2202 can serve in a role as a client, network component, a server, a database or other persistency, or any other component (or a combination of roles) of a computer system for performing the subject matter described in the instant disclosure. The illustrated electronic device 2202 is communicably coupled with a network 2230. In some implementations, one or more components of the electronic device 2202 may be configured to operate within environments, including cloud-computing-based, local, global, or other environment (or a combination of environments).

At a high level, the electronic device 2202 is an electronic computing device operable to receive, transmit, process, store, or manage data and information associated with the described subject matter. According to some implementations, the electronic device 2202 may also include, or be communicably coupled with, an application server, e-mail server, web server, caching server, streaming data server, or other server (or a combination of servers).

The electronic device 2202 can receive requests over network 2230 from a client application (for example, executing on another electronic device 2202) and respond to the received requests by processing the received requests using an appropriate software application(s). In addition, requests may also be sent to the electronic device 2202 from internal users (for example, from a command console or by other appropriate access methods), external or third-parties, other automated applications, as well as any other appropriate entities, individuals, systems, or computers.

Each of the components of the electronic device 2202 can communicate using a system bus. In some implementations, any or all of the components of the electronic device 2202, hardware or software (or a combination of both hardware and software), may interface with each other or the interface 2204 (or a combination of both), over the system bus using an application programming interface (API) 2212 or a service layer 2213 (or a combination of the API 2212 and service layer 2213). The API 2212 may include specifications for routines, data structures, and object classes. The API 2212 may be either computer-language independent or dependent and refer to a complete interface, a single function, or even a set of APIs. The service layer 2213 provides software services to the electronic device 2202 or other components (whether or not illustrated) that are communicably coupled to the electronic device 2202. The functionality of the electronic device 2202 may be accessible for all service consumers using this service layer. Software services, such as those provided by the service layer 2213, provide reusable, defined functionalities through a defined interface. For example, the interface may be software written in JAVA, C++, or other suitable language providing data in extensible markup language (XML) format or other suitable formats. While illustrated as an integrated component of the electronic device 2202, alternative implementations may illustrate the API 2212 or the service layer 2213 as stand-alone components in relation to other components of the electronic device 2202 or other components (whether or not illustrated) that are communicably coupled to the electronic device 2202. Moreover, any or all parts of the API 2212 or the service layer 2213 may be implemented as child or sub-modules of another software module, enterprise application, or hardware module without departing from the scope of this disclosure.

The electronic device 2202 includes an interface 2204. Although illustrated as a single interface 2204 in FIG. 22, two or more interfaces 2204 may be used according to particular needs, desires, or particular implementations of the electronic device 2202. The interface 2204 is used by the electronic device 2202 for communicating with other systems that are connected to the network 2030 (whether illustrated or not) in a distributed environment. Generally, the interface 2204 includes logic encoded in software or hardware (or a combination of software and hardware) and is operable to communicate with the network 2230. In some implementations, interface 2204 includes input/output (I/O) interface and network interface. In some examples, the interface 2204 may include software supporting one or more communication protocols associated with communications such that the network 2230 or interface's hardware is operable to communicate physical signals within and outside of the illustrated electronic device 2202.

The electronic device 2202 includes a processor 2205. Although illustrated as a single processor 2205 in FIG. 22, two or more processors may be used according to particular needs, desires, or particular implementations of the electronic device 2202. Generally, the processor 2205 executes instructions and manipulates data to perform the operations of the electronic device 2202 and any algorithms, methods, functions, processes, flows, and procedures as described in the instant disclosure.

The electronic device 2202 also includes a database 2006 that can hold data for the electronic device 2202 or other components (or a combination of both) that can be connected to the network 2230 (whether illustrated or not). For example, database 2206 can be an in-memory, conventional, or other type of database storing data consistent with this disclosure. In some implementations, database 2206 can be a combination of two or more different database types (for example, a hybrid in-memory and conventional database) according to particular needs, desires, or particular implementations of the electronic device 2202 and the described functionality. Although illustrated as a single database 2206 in FIG. 22, two or more databases (of the same or combination of types) can be used according to particular needs, desires, or particular implementations of the electronic device 2202 and the described functionality. While database 2206 is illustrated as an integral component of the electronic device 2202, in alternative implementations, database 2206 can be external to the electronic device 2202.

The electronic device 2202 also includes a memory 2207 that can hold data for the electronic device 2202 or other components (or a combination of both) that can be connected to the network 2230 (whether illustrated or not). For example, memory 2207 can include a non-transitory computer readable storage medium or other computer program product that store executable instructions configured for execution by one or more processors 2205 for performing the functionality described in this disclosure. Memory 2207 can be Random Access Memory (RAM), Read Only Memory (ROM), optical, magnetic, and the like, storing data consistent with this disclosure. In some implementations, memory 2207 can be a combination of two or more different types of memory (for example, a combination of RAM and magnetic storage) according to particular needs, desires, or particular implementations of the electronic device 2202 and the described functionality. Although illustrated as a single memory 2207 in FIG. 22, two or more memories 2207 (of the same or a combination of types) can be used according to particular needs, desires, or particular implementations of the electronic device 2202 and the described functionality. While memory 2207 is illustrated as an integral component of the electronic device 2202, in alternative implementations, memory 2207 can be external to the electronic device 2202.

The application 2208 is an algorithmic software engine providing functionality according to particular needs, desires, or particular implementations of the electronic device 2202, particularly with respect to functionality described in this disclosure. For example, application 2208 can include one or more of a social network application, image/video/audio editing/presentation application, etc. Application 2208 can serve as one or more components, modules, or applications. Further, although illustrated as a single application 2208, the application 2208 may be implemented as multiple applications 2208 on the electronic device 2202. In addition, although illustrated as integral to the electronic device 2202, in alternative implementations, the application 2208 can be external to the electronic device 2202. For example, one or more programs of the application 2208 can execute on an application server remote to the electronic device 2202.

The electronic device 2202 can also include a power supply 2214. The power supply 2214 can include a rechargeable or non-rechargeable battery that can be configured to be either user- or non-user-replaceable. In some implementations, the power supply 2214 can include power-conversion or management circuits (including recharging, standby, or other power management functionality). In some implementations, the power supply 2214 can include a power plug to allow the electronic device 2202 to be plugged into a wall socket or other power source to, for example, power the electronic device 2202 or recharge a rechargeable battery.

There may be any number of computers 2202 associated with, or external to, a computer system containing electronic device 2202, each electronic device 2202 communicating over network 2230. Further, the term “client,” “user,” and other appropriate terminology may be used interchangeably, as appropriate, without departing from the scope of this disclosure. Moreover, this disclosure contemplates that many users may use one electronic device 2202, or that one user may use multiple computers 2202.

Although specific configurations and arrangements are discussed, it should be understood that this is done for illustrative purposes only. As such, other configurations and arrangements can be used without departing from the scope of the present disclosure. Also, the present disclosure can also be employed in a variety of other applications. Functional and structural features as described in the present disclosures can be combined, adjusted, and modified with one another and in ways not specifically depicted in the drawings, such that these combinations, adjustments, and modifications are within the scope of the present disclosure.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described example implementations, but should be defined only in accordance with the following claims and their equivalents. Accordingly, other implementations also are within the scope of the claims.

What is claimed is:

1. A method, comprising:
receiving, by an electronic device, user input of at least a part of content of a post on a post editing page of an application on the electronic device;
generating, based on the at least a part of content of the post, a suggested title of the post;
providing, on the post editing page, the suggested title of the post;
receiving a user confirmation of the suggested title of the post; and
in response to receiving the user confirmation, displaying the suggested title of the post on the post editing page.

2. The method of claim 1, wherein generating, based on the at least a part of content of the post, the suggested title of the post comprises:
sending the at least the part of content of the post to one or more pre-trained generative artificial intelligence (GenAI) models; and
receiving the suggested title of the post outputted by the one or more pre-trained GenAI models.

3. The method of claim 2, wherein the one or more pre-trained GenAI models are executed in a remote server.

4. The method of claim 2, wherein the one or more pre-trained GenAI models are executed in the electronic device.

5. The method of claim 1, wherein the at least a part of content of the post comprises at least one of graphical content items or textual content items.

6. The method of claim 5, wherein:
the at least a part of content of the post comprises one or more graphical content items; and
receiving, by the electronic device, the user input of at least a part of content of the post on the post editing page of the application on the electronic device comprises:
receiving, by the electronic device, the one or more graphical content items at the post editing page of the application on the electronic device; and
generating, based on the at least a part of content of the post, the suggested title of the post comprises:
generating, based on the one or more graphical content items, a textual description of the one or more graphical content items using a first model; and
generating, based on the textual description of the graphical content items, the suggested title of the post using a second model.

7. The method of claim 5, wherein:
the at least a part of content of the post comprises one or more graphical content items and one or more textual content items;
receiving, by the electronic device, the user input of at least a part of content of the post on the post editing page of the application on the electronic device comprises:
receiving, by the electronic device, the one or more graphical content items and the one or more textual content items at the post editing page of the application on the electronic device; and
generating, based on the at least a part of content of the post, the suggested title of the post comprises:
generating, based on the one or more graphical content items, a textual description of the one or more graphical content items using a third model; and
generating, based on the one or more textual content items and the textual description of the one or more graphical content items, the suggested title of the post using a fourth model.

8. The method of claim 1, wherein:
generating, based on the at least a part of content of the post, the suggested title of the post comprises:
generating, based on the at least a part of content of the post, a plurality of titles of the post; and
providing, on the post editing page, the suggested title of the post comprises:
providing, on the post editing page, a suggestion of the plurality of titles of the post.

9. The method of claim 1, further comprising:
receiving a user instruction to continue drafting the post;
in response to receiving the user instruction, generating, based on existing content of the post, additional textual content; and
inserting the additional textual content in the post.

10. The method of claim 1, further comprising:
receiving, as a selected portion of textual content, a first user selection of a portion of textual content of the post;
in response to receiving the first user selection, displaying, on the post editing page, one or more editing options;
receiving, as a selected editing option, a second user selection of one of the one or more editing options; and
in response to the second user selection, performing an editing operation corresponding to the selected editing option on the selection portion of textual content.

11. The method of claim 1, further comprising:
providing, on the post editing page, one or more interactive elements for switching between multiple versions of user-confirmed post content; and
in response to a user interaction with one of the one or more interactive elements, replacing current content of the post with one of the multiple versions of user-confirmed post content.

12. The method of claim 1, further comprising:
receiving a user instruction to change a tone of textual content of the post;
in response to receiving the user instruction, providing one or more tone options on the post editing page;
receiving, as a selected tone option, a user selection of one of the one or more tone options; and
generating new textual content of the post that corresponds to the selected tone option.

13. The method of claim 1, further comprising:
providing, on the post editing page, a first interactive element to exit an AI-assisted editing mode;
receiving a first user interaction with the first interactive element; and
in response to receiving the first user interaction with the first interactive element, providing, on the post editing page, a second interactive element for prompting user feedback in a nondisruptive manner.

14. The method of claim 13, further comprising:
receiving a second user interaction with the second interactive element; and
in response to receiving the second user interaction, providing a feedback page.

15. The method of claim 14, further comprising:
in response to determining that no user interaction with the second interactive element is received within a threshold duration, dismissing the second user interaction, from displaying on the post editing page.

16. An apparatus, comprising:
one or more processors; and
one or more computer-readable memories coupled to the one or more processors and having instructions stored thereon, wherein the instructions are executable by the one or more processors to perform operations comprising:
receiving user input of at least a part of content of a post on a post editing page of an application on the apparatus;
generating, based on the at least a part of content of the post, a suggested title of the post;
providing, on the post editing page, the suggested title of the post;
receiving a user confirmation of the suggested title of the post; and
in response to receiving the user confirmation, displaying the suggested title of the post on the post editing page.

17. A non-transitory computer readable storage medium, wherein the non-transitory computer readable storage medium stores programing instructions executable by one or more processors to perform operations comprising:
receiving, by an electronic device, user input of at least a part of content of a post on a post editing page of an application on the electronic device;
generating, based on the at least a part of content of the post, a suggested title of the post;
providing, on the post editing page, the suggested title of the post;
receiving a user confirmation of the suggested title of the post; and
in response to receiving the user confirmation, displaying the suggested title of the post on the post editing page.

18. The non-transitory computer readable storage medium according to claim 17, wherein the non-transitory computer readable storage medium stores programing instructions executable by the one or more processors to perform operations comprising:
sending the at least the part of content of the post to one or more pre-trained generative artificial intelligence (GenAI) models; and
receiving the suggested title of the post outputted by the one or more pre-trained GenAI models.

19. The non-transitory computer readable storage medium according to claim 18, wherein the one or more pre-trained GenAI models are executed in a remote server.

20. The non-transitory computer readable storage medium according to claim 18, wherein the non-transitory computer readable storage medium stores programing instructions executable by the one or more processors to perform operations comprising:
generating, by the electronic device based on the at least the part of content of the post, the suggested title of the post using one or more pre-trained GenAI models.
